(19) United States
(12) Patent Application Publication
(10) Pub. No.: US 2026/0341907 A1
(43) Pub. Date: Oct. 29, 2026

(54) POROUS INSULATING LAYER-APPLIED MATERIAL FOR ADHERING ELECTROCHEMICAL ELEMENT MEMBER, STACK, ELECTRODE, ELECTROCHEMICAL ELEMENT, METHOD OF PRODUCING STACK, METHOD OF PRODUCING ELECTRODE, AND METHOD OF ELECTROCHEMICAL ELEMENT

(71) Applicants: Nozomi Terai, Saitama (JP); Keigo Takauji, Kanagawa (JP); Miku Ohkimoto, Kanagawa (JP)

(72) Inventors: Nozomi Terai, Saitama (JP); Keigo Takauji, Kanagawa (JP); Miku Ohkimoto, Kanagawa (JP)

(73) Assignee: Ricoh Company, Ltd., Tokyo (JP)

(21) Appl. No.: 19/110,708

(22) PCT Filed: Sep. 13, 2023
(86) PCT No.: PCT/IB2023/059053

§ 371 Date: Mar. 11, 2025

(30) Foreign Application Priority Data
Sep. 30, 2022 (JP) 2022-157940

(51) Int. Cl. H01M 50/46; H01M 10/0585; H01M 50/42; H01M 50/491

(52) U.S. Cl. CPC H01M 50/461; H01M 10/0585; H01M 50/42; H01M 50/491

(57) ABSTRACT

A porous insulating layer-applied material includes a base material; and an adhesive porous insulating layer on the base material; where the adhesive porous insulating layer is a porous structure having an co-continuous structure including a resin as a backbone; the resin is a cross-linked resin; and the adhesive porous insulating layer gives a peel strength of 2 N/m or more in a peel measuring method with use of a peel strength measuring element derived by preparing the base material as one of two base materials each having a size of 30 mm×100 mm, disposing the adhesive porous insulating layer through one entire face of each of the two base materials to provide adhesive porous insulating layers, placing the adhesive porous insulating layers to face each other, and performing thermal adhesion under conditions at a temperature of 140 °C and an air cylinder thrust of 500 N for 1 minute.

### TECHNICAL FIELD

The present disclosure relates to a porous insulating layer-applied material for adhering an electrochemical element member, a stack, an electrode, an electrochemical element, a method of producing a stack, a method of producing an electrode, and a method of producing an electrochemical element.

### BACKGROUND ART

In daily life in recent years, smartphones and laptop computers have been widespread, and electric vehicles, which have no internal combustion, have come to draw attention worldwide toward decarbonized carbon society. These electronic appliances carry a lithium-ion secondary battery characterized by having high output power and high energy density. Current typical batteries include electrodes not fixed to one another in most cases, and have a problem in that stacking slippage is likely to occur at stacking of electrodes. Since stacking slippage of an electrode inside a battery would lead to reduction in a good battery property and stability, it is preferred to prevent stacking slippage of an electrode.

So far, an exemplary secondary battery with less falloff of resin particles of an insulating layer stacked on an electrode active material layer has been reported as including a porous insulating layer formed by binding to and stacking on at least one surface of a positive electrode active material layer or a negative electrode active material layer so as to cover at least one of the positive electrode active material layer or the negative electrode active material layer; and a molten part formed on the edge of the insulating layer and solidified with loss of voids by melting of the resin particles in the insulating layer (see, e.g., Patent Literature 1).

In addition, an exemplary power storage device has been reported as including a power storage unit and an electrolyte; wherein the power storage unit includes a first insulating layer that adheres to a part of a surface of a positive electrode and a part of a surface of a negative electrode and separates the positive electrode and the negative electrode, and a region enclosed by the first insulating layer in a planar view and serving to retain an electrolyte between the positive electrode and the negative electrode; and wherein the first insulating layer has an air permeability of more than 1250 secs/100 cc and less than 95000 secs/100 cc (see, e.g., Patent Literature 2).

### CITATION LIST

### Patent Literature

### [PTL 1]

Japanese Unexamined Patent Application Publication No. 2016-33930

### [PTL 2]

WO2013/002138

### SUMMARY OF INVENTION

### Technical Problem

The present invention has an objective to provide a porous insulating layer-applied material for adhering an electrochemical element member, wherein the porous insulating layer-applied material has excellent flexibility and ion permeability in an insulating layer, allows reduction of occurrence of stacking slippage of an electrode, and enables production of an electrochemical element having an excellent battery property.

### Solution to Problem

A porous insulating layer-applied material for adhering an electrochemical element member according to an embodiment of the present invention as a way of solving the problem includes a base material and an adhesive porous insulating layer on the base material; wherein the adhesive porous insulating layer is a porous structure having a co-continuous structure including a resin as a backbone; wherein the resin is a cross-linked resin; and wherein the adhesive porous insulating layer gives a peel strength of 2 N/m or more in a peel measuring method with use of a peel strength measuring element derived by preparing the base material as one of two base materials each having a size of 30 mm×100 mm, disposing the adhesive porous insulating layer through one entire face of each of the two base materials to provide adhesive porous insulating layers, placing the adhesive porous insulating layers to face each other, and performing thermal adhesion under conditions at a temperature of 140 °C and an air cylinder thrust of 500 N for 1 minute.

### Advantageous Effects of Invention

Embodiments of the present invention can provide a porous insulating layer-applied material for adhering an electrochemical element member, wherein the porous insulating layer-applied material has excellent flexibility and ion permeability in an insulating layer, allows reduction of occurrence of stacking slippage of an electrode, and enables production of an electrochemical element having an excellent battery property.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings

FIG. 1 is a schematic plan view of an applied region of a porous insulating layer according to an embodiment of the present invention.

FIG. 2 is a schematic cross-sectional view of an electrode according to an embodiment of the present invention.

FIG. 3 is a schematic cross-sectional view of a stack according to an embodiment of the present invention.

FIG. 4 is a schematic cross-sectional view of an electrode according to an embodiment of the present invention.

FIG. 5 is a schematic cross-sectional view of a stack according to an embodiment of the present invention.

FIG. 6 is a schematic cross-sectional view of a stack according to an embodiment of the present invention.

FIG. 7 is a schematic plan view of an applied region of a porous insulating layer according to an embodiment of the present invention.

FIG. 8 is a schematic plan view of an applied region of a porous insulating layer according to an embodiment of the present invention.

FIG. 9 is a schematic cross-sectional view of an electrode according to an embodiment of the present invention.

FIG. 10 is a schematic cross-sectional view of an electrode according to an embodiment of the present invention.

FIG. 11 is a schematic cross-sectional view of an electrode according to an embodiment of the present invention.

FIG. 12 is a schematic cross-sectional view of a stack according to an embodiment of the present invention.

FIG. 13 is a schematic cross-sectional view of a stack according to an embodiment of the present invention.

FIG. 14 is a schematic cross-sectional view of a stack according to an embodiment of the present invention.

FIG. 15 is a schematic cross-sectional view of a stack according to an embodiment of the present invention.

FIG. 16A is a schematic plan view of a porous insulating layer.

FIG. 16B is a schematic plan view of a porous insulating layer.

FIG. 17 is a schematic view of a production apparatus for an adhesive porous insulating layer according to an embodiment of the present invention.

FIG. 18 is a schematic view of a liquid discharge apparatus being a modification of the apparatus illustrated in FIG. 17.

FIG. 19 is a schematic view of a production apparatus for an adhesive porous insulating layer according to an embodiment of the present invention.

FIG. 20 is a schematic view of a liquid discharge apparatus, which is a production apparatus for an adhesive porous insulating layer according to an embodiment of the present invention.

FIG. 21 is a schematic view of a liquid discharge apparatus being a modification of the apparatus illustrated in FIG. 20.

FIG. 22 is a configuration diagram illustrating a printing part using a drum-shaped intermediate transfer body as a production apparatus for an adhesive porous insulating layer according to an embodiment of the present invention.

FIG. 23 is a configuration diagram illustrating a printing part using an endless belt-type intermediate transfer body as a production apparatus for an adhesive porous insulating layer according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### (Porous Insulating Layer-Applied Material for Adhering an Electrochemical Element Member)

A porous insulating layer-applied material for adhering an electrochemical element member according to an embodiment of the present invention has a base material, and an adhesive porous insulating layer on the base material; wherein the adhesive porous insulating layer is a porous structure having an co-continuous structure including a resin as a backbone; wherein the resin is a cross-linked resin; and wherein the adhesive porous insulating layer gives a peel strength of 2 N/m or more in a peel measuring method with use of a peel strength measuring element derived by preparing the base material as one of two base materials each having a size of 30 mm×100 mm, disposing the adhesive porous insulating layer through one entire face of each of the two base materials to provide adhesive porous insulating layers, placing the adhesive porous insulating layers to face each other, and performing thermal adhesion under conditions at a temperature of 140 °C and an air cylinder thrust of 500 N for 1 minute. The porous insulating layer-applied material for adhering an electrochemical element member is used for adhesive application of an electrochemical element member, and has an adhesive insulating layer.

The porous insulating layer-applied material for adhering an electrochemical element member according to an embodiment of the present invention is based on that the inventors found the following problem in conventional arts.

That is, a conventionally known battery electrode has an insulating adhesive applied to reduce falloff of resin particles in an insulating layer (see Patent Literature 1, etc.). However, such a battery electrode has a problem in that use of a material that exerts adhesiveness by thermal gluing involves melting of resin particles in an insulating layer and thus loss of voids, thereby reducing porosity and causing a reduced insulation property of the insulating layer.

An insulating adhesive is preferably a porous material that does not inhibit circulation of an electrolytic solution inside a cell and has high porosity. However, there is a problem in that higher air permeability (porosity) in an insulating layer leads to reduction in strength of the insulating layer, as seen in, e.g., a power storage device in Patent Literature 2.

Particularly, application of batteries such as a power storage element including a battery or a power-generating element including a fuel cell has a problem in that when a porous structure in conventional art is formed on an electrode as a base material and used as an insulating layer, reduction in porosity in the porous structure results in insufficient permeability of a substance, thus making it difficult to maintain ion permeability and leading to reduction in performance of a battery.

Furthermore, since stacking slippage of an electrode inside a battery would lead to reduction in a good battery property and stability, it is preferred to prevent occurrence of stacking slippage of an electrode. According to findings, it is preferred to combine a trade-off relation between ion permeability (porosity) of an insulating layer and strength of an insulating layer, as well as to provide an insulating layer with not only strength but also sufficient flexibility to deal with stacking slippage of an electrode.

The inventors earnestly investigated to solve the problems, and consequently found that the porous insulating layer-applied material for adhering an electrochemical element member according to an embodiment of the present invention has excellent flexibility and ion permeability in an insulating layer, allows reduction of occurrence of stacking slippage of an electrode, and enables provision of a porous insulating layer-applied material for adhering an electrochemical element member that can produce an electrochemical element having an excellent battery property; and achieved completion of the present invention.

### <Base Material>

The base material can be any material regardless of a transparent or opaque one, appropriately selected corresponding to a purpose.

Examples of the transparent base material include, but are not limited to, glass base materials, resin film base materials such as various plastic films, and composite substrates thereof. Examples of the opaque base material include, but are not limited to, silicon base materials; metal base materials such as stainless steel, aluminum, and copper; recording medium; and stacks thereof.

The recording medium may be plain paper, gloss paper, special paper, or fabric, or a low-permeable base material (low absorptive base material). The low-permeable base material refers to a base material having a surface with a low level of moisture permeability, absorptivity, or absorptivity; and also encompasses a material having a number of hollow spaces inside but not opened to the exterior. Examples of the low-permeable base material may include, but are not limited to, coated paper used in commercial printing, and recording media such as surface-coated paperboard including intermediate and back layers each containing waste paper pulp.

The base material may be a porous insulating layer such as a porous resin sheet used as an insulating layer for an electrochemical element, or a paper separator containing cellulose fiber, or may be an electrode base for an electrochemical element, or an electrode composite layer on an electrode base.

The shape of the base material may have a curved surface or a bumpy shape, and a base material applicable for an application unit and a polymerization unit in a production apparatus for a stack can be appropriately selected and used.

### <Adhesive Porous Insulating Layer>

The adhesive porous insulating layer is disposed on the base material.

The adhesive porous insulating layer is a porous structure having an co-continuous structure including a resin as a backbone, and has a peel strength of 2 N/m or more and thermal adhesiveness.

The term “thermal adhesiveness” in the specification and claims means that heating causes exertion of adhesiveness to another substance. An example showing the exertion of adhesiveness is improved peel strength between a structure having thermal adhesiveness by heating and another substance.

The specific volume resistivity of the adhesive porous insulating layer is preferably 1×1012 (Ω·cm) or more.

### —Porous Structure—

The porous structure (hereinafter sometimes referred to as porous resin) has an co-continuous structure including a resin as a backbone.

The resin is preferably a cross-linked resin, as well as a polymerization product of a polymerizable compound that is polymerizable by energy irradiation.

The term “co-continuous structure” herein means a structure including two or more substances or phases each having a continuous structure and forming no interface, and refers to, in the embodiment, a structure where both of a resin phase and a void phase form a three-dimensional branched network continuous phase. Such a structure can be formed by, e.g., polymerizing the liquid composition described later by polymerization-induced phase separation.

### [Glass Transition Temperature]

When the resin is a cross-linked resin, heating to exert adhesiveness to perform adhering to another substance does not result in melting of the cross-linked resin and thus is less likely to cause large change of shape. This allows the adhesive porous insulating layer to maintain a good insulation property both before and after heat adhesion.

To function as an adhesive layer, the adhesive porous insulating layer should have appropriate glass transition temperature (Tg) of a cross-linked resin to be a backbone.

The glass transition temperature (Tg) of the adhesive porous insulating layer is preferably 0 °C or more to 100 °C or less, and more preferably 25 °C or more to 60 °C or less.

Having lower than 0 °C as the Tg is not preferable because a cross-linked resin exhibits stickiness on its surface at normal temperature, thus making operations difficult after formation of the adhesive porous insulating layer.

Having higher than 100 °C as the Tg is not preferable because heat adhesion is less likely to provide good adhesiveness and higher temperature is required for heat adhesion, thus often causing a harmful effect on another surrounding base material due to overheat. By contrast, having 0 °C or more to 100 °C or less as the Tg is favorable in view of providing good operability before and after heat adhesion, good adhesiveness after heat adhesion, and no harmful effect due to overheat.

Providing the porous structure with an co-continuous structure including a three-dimensional branched network structure as a backbone allows achieving a porous structure with high porosity and high strength.

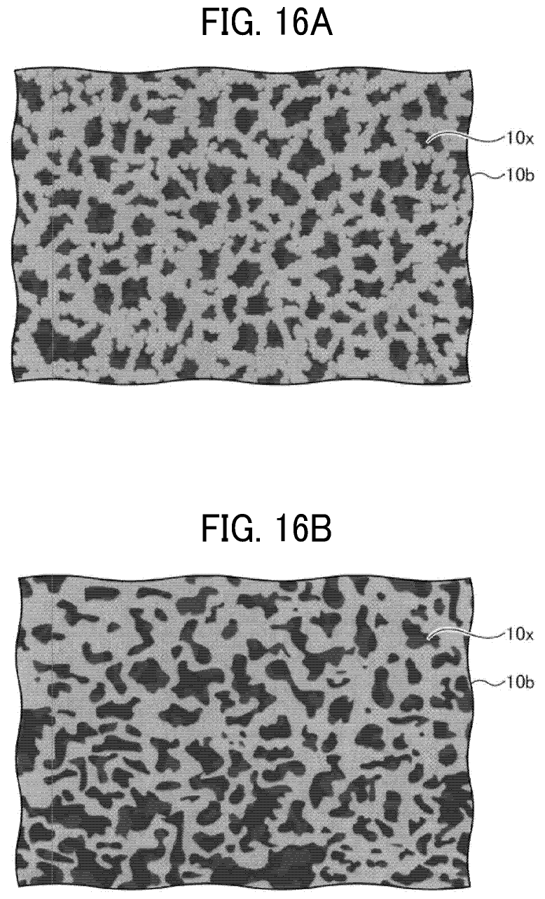

In other words, as shown in FIG. 16A and FIG. 16B, an adhesive porous insulating layer 10b has a plurality of voids 10×, and one of the voids 10× is three-dimensionally spread with having communication with another of the voids 10× around the one of the voids 10×.

The porous structure having an co-continuous structure including communication between the voids causes sufficient permeation of an electrolyte and no prevention of ion transfer.

An exemplary method of confirming presence of the co-continuous structure and the communication of the voids is a method of observing a cross-sectional image of the porous structure with a scanning electron microscope (SEM) to check a continuous connection of the pores. One physical property obtained by the communication of the voids is air permeability.

[Image Observation with Scanning Electron Microscope (SEM), and Measurement of Porosity]

The porosity of the porous structure is preferably 30% or more, and more preferably 50% or more, and also preferably 90% or less, and more preferably 85% or less.

With a porosity of 30% or more, the porous structure enables liquids or gases to sufficiently permeate, thereby efficiently exerting a function such as separation of a substance or supply of a reaction field. Use of the porous structure as an insulating layer in a power storage element improves permeability of an electrolytic solution and permeation of ions, and efficiently progresses an internal reaction of the power storage element. Meanwhile, with a porosity of 90% or less, the porous structure has improved strength.

A method of evaluating porosity of the porous structure is not particularly limited and can be appropriately selected corresponding to a purpose. Examples thereof include, but are not limited to, a method by subjecting a porous structure to osmium staining, cutting out an inner cross-sectional structure with a focused ion beam (FIB), and measuring porosity with a scanning electron microscope (SEM).

In particular, the porosity can be measured by the following procedure.

That is, a porous structure is clipped to 5 mm×10 mm in size, and subjected to osmium staining with osmium (VIII) oxide (manufactured by Nisshin-EM Co., Ltd.). The adhesive porous insulating layer thus clipped is put into a bottle containing a small amount of an aqueous solution thereof so as not to contact the aqueous solution, and left to stand in a sealed bottle for 30 minutes to be stained. Then, the layer is dried in a draft for 1 hour to provide a sample.

After sufficient drying, the sample is vacuum-impregnated with a two-component epoxy resin (manufactured by ITW Performance Polymers & Fluids Japan Co., Ltd.). Then, a cross section is cut at 5.0 kV with a cross section polisher (manufactured by JEOL Ltd.), and observed with a cryoFIB/SEM (manufactured by FEI Company Japan Ltd.).

The porosity of the porous structure is calculated by binarizing the observed image and deriving a proportion of pores in an observation area.

### [Air Permeability]

The air permeability of the porous structure is preferably 1,000 secs/100 mL or less, more preferably 500 seconds/100 mL or less, and even more preferably 300 secs/100 mL or less. The air permeability is air permeability measured in accordance with JIS P8117, and can be measured using e.g., a Gurley densometer (manufactured by Toyo Seiki Seisaku-sho, Ltd.). For instance, communication of voids may be determined by exhibiting an air permeability of 1,000 secs/100 mL or less.

The cross-sectional shapes of pores of the porous resin may have various shapes, such as a substantially circular shape, a substantially elliptical shape, or a substantially polygonal shape, and various sizes. Here, the size of a pore refers to the length of the longest portion in the cross-sectional shape of the pore. The size of a pore can be derived from a cross-sectional image taken with a scanning electron microscope (SEM).

The size of a pore of the porous resin is not particularly limited, and can be appropriately selected corresponding to a purpose, but is, in view of liquid or gas permeability, preferably 0.01 μm or more to 10 μm or less.

With a pores is 0.1 μm or more to 10 μm or less, the porous structure enables liquids or gases to sufficiently permeate, thereby efficiently exerting a functions such as separation of a substance or supply of a reaction field. As will be described later, when the porous structure is used as an insulating layer of a power storage element, providing a pore size of 10 μm or less allows prevention of a short circuit between a positive electrode and a negative electrode due to lithium dendrite generated inside the power storage element, thereby improving safety. A method for adjusting the pore size and the porosity of the porous resin to such ranges is not particularly limited. Examples thereof include, but are not limited to, a method of adjusting the content of a polymerizable compound in a liquid composition to the aforementioned ranges, a method of adjusting the content of porogen in a liquid composition to the aforementioned ranges, and a method of adjusting an irradiation condition of active energy rays.

The average thickness of the adhesive porous insulating layer is not particularly limited and can be appropriately selected corresponding to a purpose, but is preferably 1.0 μm or more to 150.0 μm or less, and more preferably 10.0 μm or more to 100.0 μm or less. With an average thickness of 10.0 μm or more, good adhesive strength can be provided in thermal adhesion to another electrode. With an average thickness of 100.0 μm or less, the adhesive porous insulating layer can be provided with flexibility.

The average thickness is appropriately adjusted corresponding to an application with use of a porous resin.

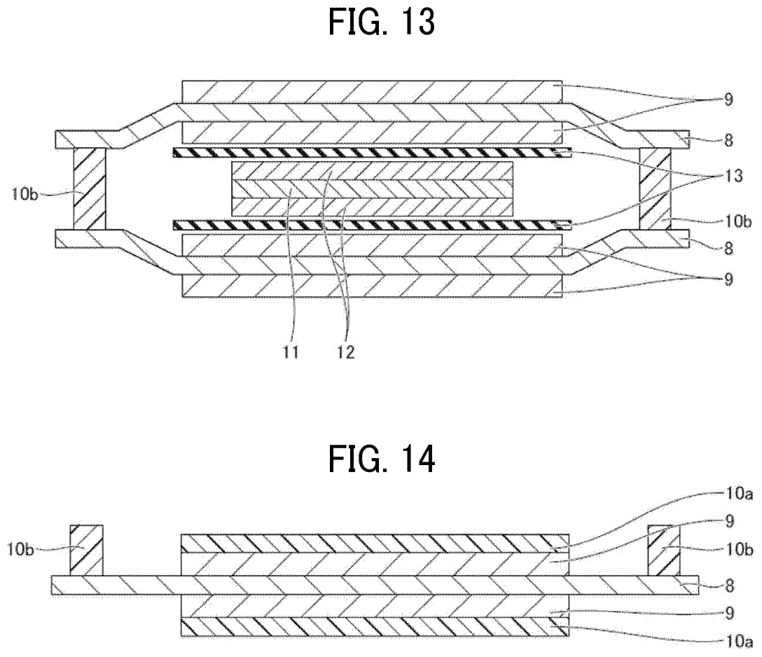

Most preferably, the average thickness is adjusted corresponding to the thickness of facing electrodes. As shown in FIG. 13, a cross-sectional structure after cell formation is preferably formed such that a space thickness formed by adhesive layers has a thickness comparable to the film thickness of facing electrodes. This allows reduction in strain generated in the edge of a stack electrode after battery stacking.

The average thickness can be derived by measuring thicknesses at any three or more points and calculating an average thereof.

The term of thickness refers to a thickness formed of only porous resin layers. For example, when a porous resin layer infiltrates a base material, the thickness of a layer including the porous resin layer and the base material is not counted.

The adhesive porous insulating layer enables thermal adhesion e.g., in combination of an electrode having the adhesive porous insulating layer applied thereon and another electrode, and allows reducing slippage in an electrode stack that occurs at battery stacking or at a post-stacking step. Accordingly, the formation site of the adhesive porous insulating layer is not particularly limited as long as it can exert the adhesive effect described above, and the adhesive porous insulating layer can be formed at any position such as on an electrode base, an electrode composite layer, or a porous insulating layer. Note that although positioning on a side facing a facing electrode can provide the aforementioned functions, the adhesive porous insulating layer is preferably formed in an area not facing a facing electrode so as not to interfere ion permeability between electrodes.

### [Peel Strength]

The peel strength of the adhesive porous insulating layer is peel strength by a peel measuring method measured at room temperature (25 °C) with use of the peel strength measuring element.

The peel strength of the adhesive porous insulating layer is 2 N/m or more, preferably 5 N/m or more, and more preferably 25 N/m or more.

The peel strength measuring element is produced by preparing the base material as one of two base materials each having a size of 30 mm×100 mm, disposing the adhesive porous insulating layer through one entire face of each of the two base materials to provide adhesive porous insulating layers, placing the adhesive porous insulating layers to face each other, and performing thermal adhesion under conditions at a temperature of 140 °C and an air cylinder thrust of 500 N for 1 minute.

The peel strength can be measured using, e.g., the adherence/coating peeling analyzer Versatile Peel Analyzer (manufactured by Kyowa Interface Science Co., Ltd.) as a peel strength measuring device, particularly by the following procedure.

A side facing a side forming an adhesive porous insulating layer in base a of a peel strength measuring element, and a sample fixing face in a peel strength measuring device are fixed together with a thin double-sided tape. Then, a side facing a side forming an adhesive porous insulating layer in base b of the peel strength measuring element, and a tensile indenter of the peel strength measuring device are fixed together with a tape. Peel strength is measured under the following measuring conditions.

### Measuring Conditions of Peel Strength—

Peel strength measuring device: adherent
Coating peeling analyzer Versatile Peel Analyzer (manufactured by Kyowa Interface Science Co., Ltd.)
Thin double-sided tape: No. 5000NS (20 mm in width, manufactured by Nitto Denko Corporation)
Tape: No. 29 (18 mm in width, manufactured by Nitto Denko Corporation)
Measuring speed: 30 mm/min
Peeling angle: 90°
Peeling distance: 75 mm

Peeling distance does not significantly contribute to peel strength, and thus may be any value. The thin double-sided tape and the tape for fixing a peel strength measuring element can be appropriately selected among tapes that has sufficiently higher peel strength than the peel strength of the adhesive porous insulating layer and does not peel off during measurement.

### (Stack)

A stack according to a first embodiment of the present invention includes the porous insulating layer-applied material for adhering an electrochemical element member according to an embodiment of the present invention as described, and another base material adhered via at least a part of the adhesive porous insulating layer.

Furthermore, a stack according to a second embodiment of the present invention includes a first base material and a second base material; wherein the first base material has a first adhesive porous insulating layer; wherein the first base material and the second base material are adhered via the first adhesive porous insulating layer; wherein the first adhesive porous insulating layer is a porous structure having an co-continuous structure including a resin as a backbone; wherein the resin is a cross-linked resin; and wherein the first adhesive porous insulating layer gives a peel strength of 2 N/m or more in a peel measuring method with use of a peel strength measuring element derived by disposing the first adhesive porous insulating layer through each of one entire face of the first base material having a size of 30 mm×100 mm and one entire face of the second base material having a size of 30 mm×100 mm to provide first adhesive porous insulating layers, placing the first adhesive porous insulating layers to face each other, and performing thermal adhesion under conditions at a temperature of 140 °C and an air cylinder thrust of 500 N for 1 minute.

In a preferred aspect, the second base material has a second adhesive porous insulating layer, and the first base material and the second base material form together a stack so as to cause the first adhesive porous insulating layer to face the second adhesive porous insulating layer. In an aspect, the stack may include an electrode as the first base material and a film separator as the second base material. In another aspect, the stack may include an electrode as the first base material and an electrode as the second base material. Both of the aspects can be preferably employed.

These adhesive porous insulating layers has a peel strength of 2 N/m or more and excellent adhesiveness. Therefore, inclusion of interfaces between the first adhesive porous insulating layer and each base material, and the second adhesive porous insulating layer allows retaining sufficient adhesiveness in additional interfaces between the second adhesive porous insulating layer and the second base material and between the first adhesive porous insulating layer and the second adhesive porous insulating layer or another interface, as well as reducing the content of a binder of the first adhesive porous insulating layer or the second adhesive porous insulating layer. When the first adhesive porous insulating layer or the second adhesive porous insulating layer contains a binder, melting of the binder causes closure of pores in the first adhesive porous insulating layer or the second adhesive porous insulating layer, thus preventing maintenance of porosity and reducing a battery property.

The content of a binder in the first adhesive porous insulating layer is preferably 0% by mass or more to 30% by mass or less relative to the total amount of the first adhesive porous insulating layer, and is, as a content substantially not containing a binder, more preferably 0% by mass or more to 10% by mass or less, even more preferably 0% by mass or more to 5% by mass or less, and yet more preferably 0% by mass.

In presence of the second adhesive porous insulating layer, the content of the binder is defined relative to the total amount of the first adhesive porous insulating layer and the second adhesive porous insulating layer.

### <Another Base Material, First Base Material, and Second Base Material>

In regard to said another base material, the first base material, and the second base material, the items described above for the base material can be correspondingly and appropriately selected.

The base material may be a porous resin sheet used as an insulating layer for an electrochemical element, a porous insulating layer, a paper separator containing cellulose fiber or the like, or may be an electrode base for an electrochemical element, an electrode composite layer on an electrode base, etc.

### «Porous Insulating Layer»

The porous insulating layer can be disposed on an active material, or on an electrode base and adjacent to an active material, for the purpose of ensuring a battery property and preventing short circuit.

The porous insulating layer is not particularly limited, and can be appropriately selected as a structure having a plurality of voids and a porous body layer having a specific volume resistivity of 1×10¹² (Ω·cm) or more corresponding to a purpose. Example thereof include a sheet-shaped insulating layer primarily formed of a material such as polyolefin or cellulose, and an insulating layer integrated with a base material formed on the base material such as an electrode.

Particularly preferably, the porous insulating layer is a porous structure having an co-continuous structure including a cross-linked resin as a backbone, and is a porous insulating layer having a peel strength of less than 2 N/m.

In regard to a porous structure in the porous insulating layer, particularly to characteristics other than peel strength and glass transition temperature, the items described in a porous structure in the adhesive porous insulating layer can be appropriately selected.

The peel strength of the porous structure is not particularly limited unless out of less than 2 N/m, and can be appropriately selected corresponding to a purpose.

The glass transition temperature of the porous structure is not particularly limited and can be appropriately selected corresponding to a purpose.

In regard to a method of producing a porous structure in the porous insulating layer, the items such as the liquid composition, the polymerizable compound, the liquid, and the polymerization-induced phase separation all of which are described for a porous structure in the adhesive porous insulating layer can be appropriately selected.

The average thickness of the porous resin is not particularly limited and can be appropriately selected corresponding to a purpose, but is, in view of curing uniformity at polymerization, preferably 0.01 μm or more to 500 μm or less, more preferably 0.01 μm or more to 100 μm or less, even more preferably 1 μm or more to 50 μm or less, and particularly preferably 10 μm or more to 20 μm or less. With a film thickness of 0.01 μm or more, the surface area of a resulting porous resin is larger, thereby providing sufficiently a function by the porous resin. Meanwhile, with a film thickness of 500 μm or less, unevenness of light or heat used at polymerization is reduced in a film thickness direction, thus allowing providing a porous resin that is uniform in the film thickness direction. Production of a porous resin that is uniform in a film thickness direction allows reduction in structural unevenness of the porous resin, and prevention of decrease in liquid or gas permeation.

In use of a porous resin as an insulating layer for an electrochemical element, the average thickness of the porous insulating layer is not particularly limited and can be appropriately selected corresponding to a purpose, but is preferably 1.0 μm or more to 50.0 μm or less, and more preferably 5.0 μm or more to 20.0 μm or less. Having 5.0 μm or more as the average thickness leads to less occurrence of short circuit due to bumps and dips on an active material, and having 20.0 μm or less provides good battery property.

The porous insulating layer is primarily disposed in an area where the first electrode and the second electrode face each other. That is, such an area is an area representing a reaction field of an ion in a secondary battery, and thinner film thickness of the porous insulating layer thus formed can provide a better battery property.

The term of thickness refers to a thickness formed of only porous resin layers. For example, when a porous resin layer infiltrates a base material, the thickness of a layer including the porous resin layer and the base material is not counted.

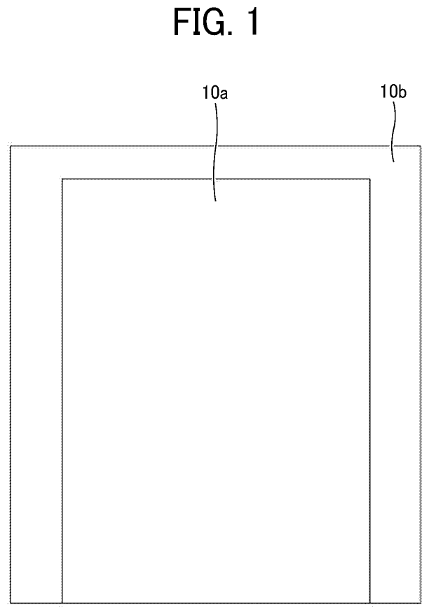

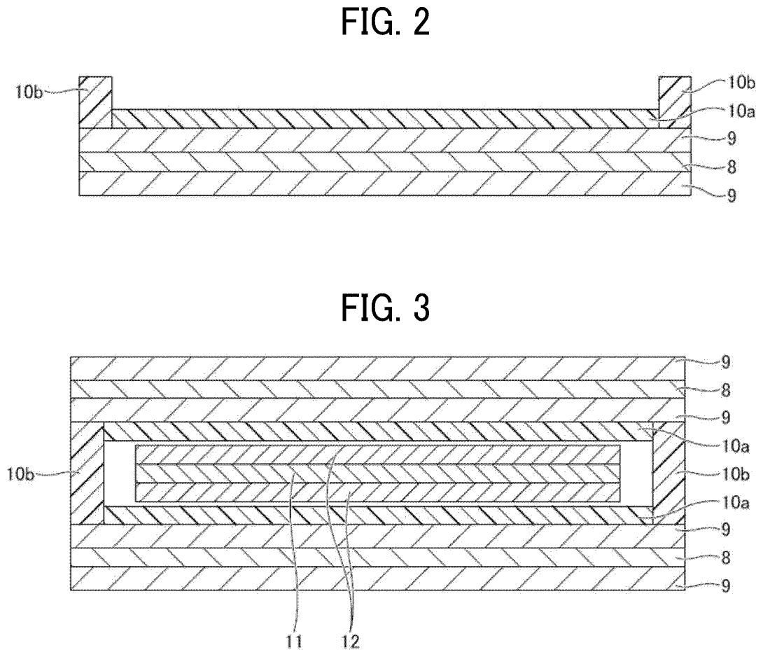

FIGS. 1 to 3 illustrates an example of a porous insulating layer-applied material for adhering an electrochemical element member (electrode), and a stack (electrochemical element) in the embodiment. FIG. 1 and FIG. 2 show a plan view and a cross-sectional view in the embodiment, respectively, and FIG. 1 indicates an applied region of the adhesive porous insulating layer 10b. In this embodiment, a porous insulating layer 10a is disposed on one face of a base material including first electrode composite layers 9 on both faces of a first electrode base 8 (on one of the first electrode composite layers 9), and the adhesive porous insulating layer 10b is disposed in a blank part around the porous insulating layer 10a on the base material.

FIG. 3 shows a cross-sectional view of a stack (electrochemical element) including an electrode illustrated in FIG. 1 and FIG. 2. In the stack in FIG. 3, the electrode illustrated in FIG. 1 and FIG. 2 (first electrode) and an electrode having the same configuration (first electrode) sandwich a second electrode including second electrode composite layers 12 on both faces of a second electrode base 11, and two separate first electrode composite layers 9 are adhered via the adhesive porous insulating layer 10b.

The adhesive porous insulating layer 10b is disposed on an outermost surface layer of an electrode, i.e., on an exposed part on a surface of the electrode, and is disposed, in the embodiment, in at least a part of the outer periphery of sides of the electrode. The adhesive porous insulating layer 10b has excellent ion permeability and thus does not prevent circulation of an electrolytic solution inside a cell, and has flexibility in an insulating layer and thus enables reduction in generation of stacking slippage of an electrode, thereby providing a good battery property and stability.

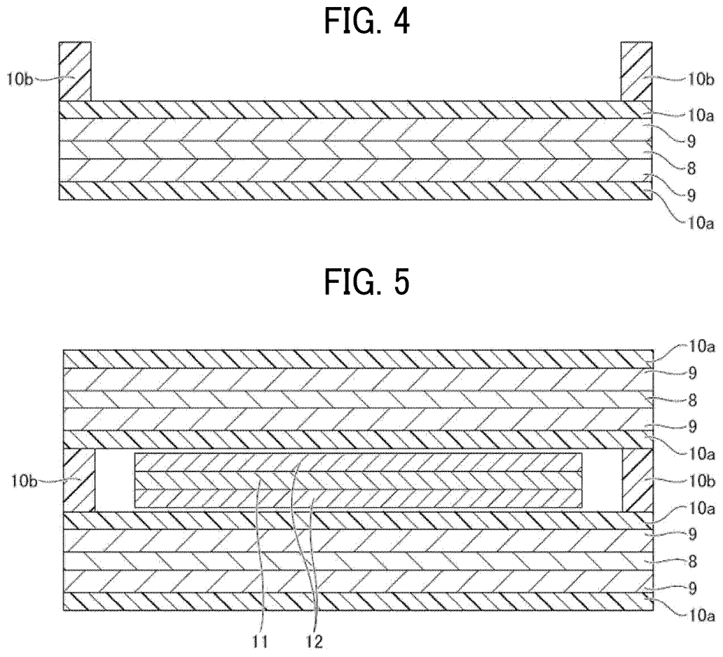

FIG. 1 and FIG. 4 to 5 show an example of a porous insulating layer-applied material for adhering an electrochemical element member (electrode) and a stack (electrochemical element) in another embodiment. FIG. 1 and FIG. 4 show a plan view and a cross-sectional view of the embodiment, respectively, and FIG. 1 shows an applied region of the adhesive porous insulating layer 10b. In this embodiment, the porous insulating layer 10a is disposed through one entire face of a base material including the first electrode base 8 having the first electrode composite layers 9 on both faces (on one of the first electrode composite layers 9), and the adhesive porous insulating layer 10b is disposed around the porous insulating layer 10a.

FIG. 5 shows a cross-sectional view of a stack having an electrode (electrochemical element) illustrated in FIG. 1 and FIG. 4. In the stack in FIG. 5, the electrode illustrated in FIG. 1 and FIG. 4 (first electrode) and an electrode having the same configuration (first electrode) sandwich a second electrode, and two separate first electrode composite layers 9 are adhered via the adhesive porous insulating layer 10b.

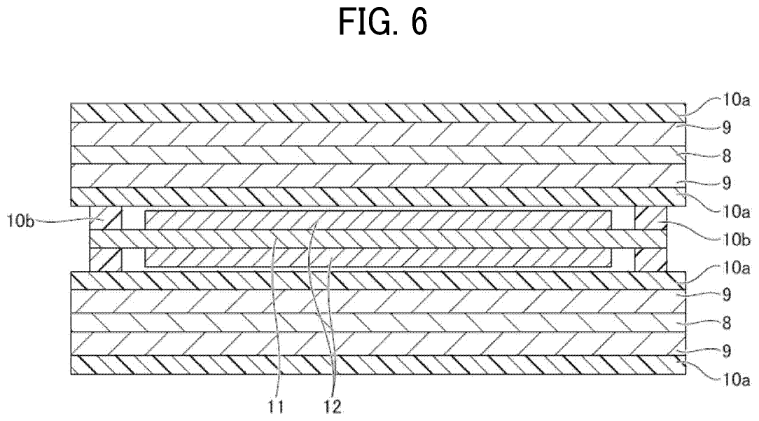

The stack illustrated in FIG. 6 represents a modification of the stack in FIG. 5. Compared to the stack in FIG. 5, the edge of the second electrode base 11 extends beyond the edge of the second electrode composite layer 12, and the second electrode base 11 and one of the first electrode composite layers 9 are adhered together via the adhesive porous insulating layer 10b. Similarly, the other of the first electrode composite layers 9 is also adhered to the other face of the second electrode base 11 via the adhesive porous insulating layer 10b.

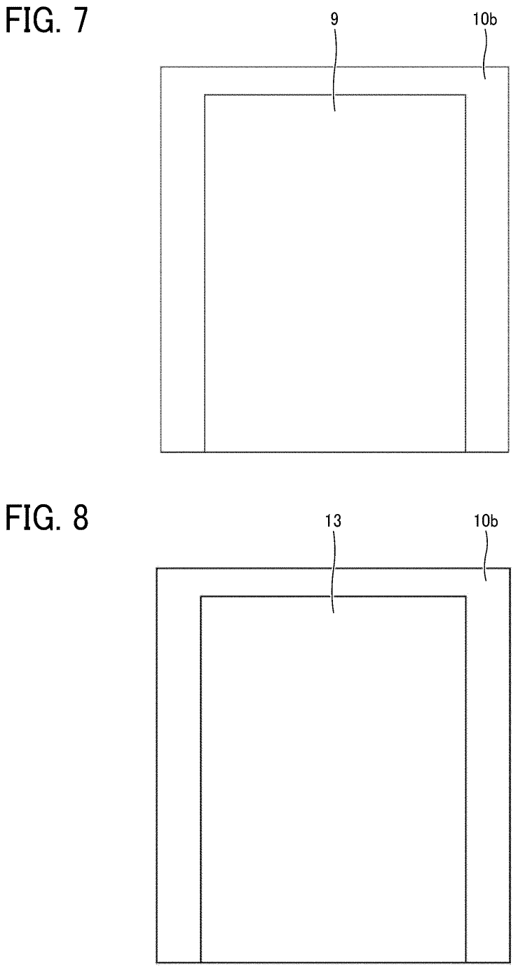

FIGS. 7 to 11 show an example of a porous insulating layer-applied material for adhering an electrochemical element member (electrode) and a stack (electrochemical element) in a further embodiment.

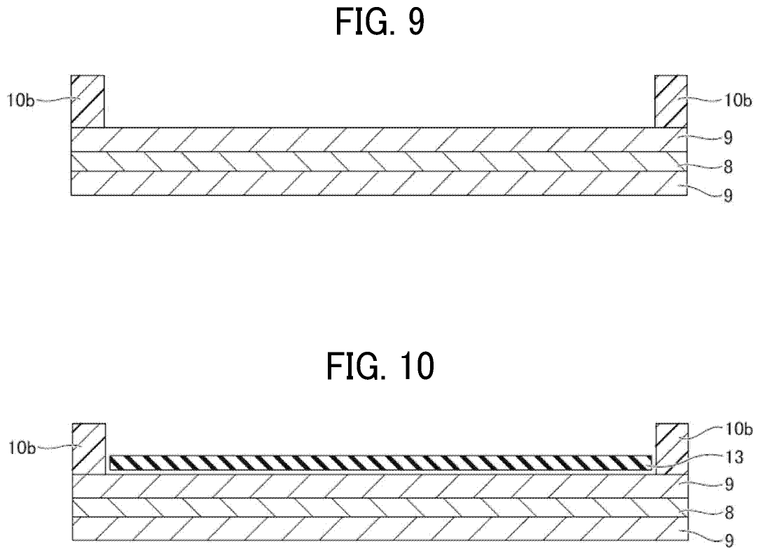

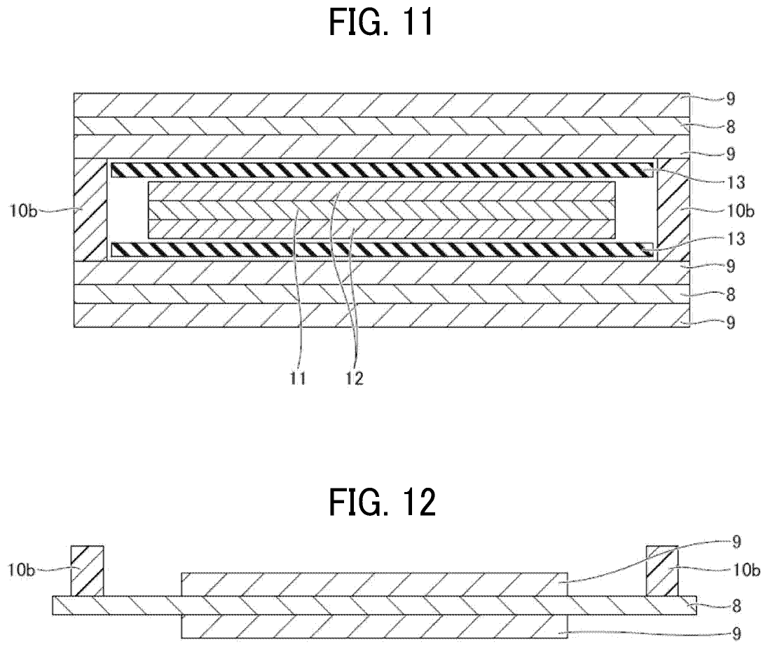

As can be seen from another modification of an applied region of the adhesive porous insulating layer 10b as illustrated in plan views of FIG. 7 and FIG. 8, the adhesive porous insulating layer 10b may be disposed on the first electrode composite layer 9 (base material) without the porous insulating layer 10a (FIG. 7), followed by disposing a sheet separator 13 instead of the porous insulating layer 10a (FIG. 8). FIG. 9 is a cross-sectional view corresponding to FIG. 7, and FIG. 10 is a cross-sectional view corresponding to FIG. 8, and FIG. 11 represents a cross-sectional view of a stack (electrochemical element) having an electrode illustrated in FIG. 8 and FIG. 10.

In addition, FIGS. 12 to 13 and FIGS. 14 to 15 show an example of a porous insulating layer-applied material for adhering an electrochemical element member (electrode), and a stack (electrochemical element) in further embodiments.

As can be seen from FIGS. 12 to 13 and FIGS. 14 to 15, the first electrode composite layers 9 are disposed on both sides of the first electrode base 8, the periphery of which is exposed, and the adhesive porous insulating layer 10b may be disposed on the exposed portion of the first electrode base 8.

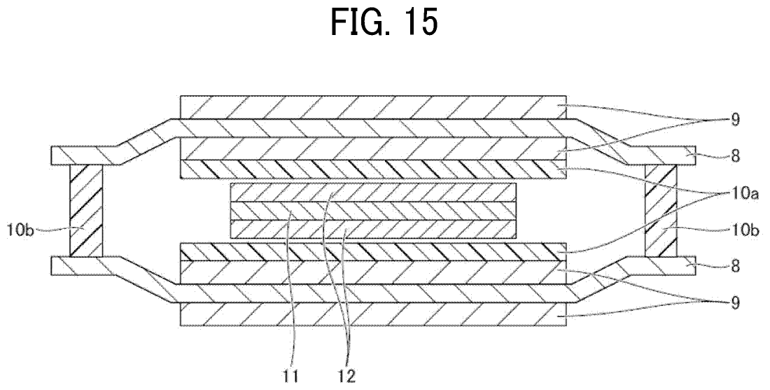

FIGS. 12 to 13 show an aspect having the sheet separator 13 as an insulating layer, and FIGS. 14 to 15 show an aspect having the porous insulating layer 10a as an insulating layer. FIG. 13 represents a cross-sectional view of a stack (electrochemical element) having the electrode illustrated in FIG. 12, and FIG. 15 represents a cross-sectional view of a stack (electrochemical element) having the electrode illustrated in FIG. 14.

All the stacks in FIG. 3, FIG. 5, FIG. 6, FIG. 11, FIG. 13, and FIG. 15 are electrochemical elements that include a first electrode, and a second electrode insulated from the first electrode, wherein the first electrode and the second electrode form together a stack.

### (Production Method for Stack and Production Apparatus for Stack)

A method of producing a stack according to an embodiment of the present invention includes an adhesive porous insulating layer formation step, a stacking step, and an adhering step, and further includes another step as appropriate.

A production apparatus for a stack according to an embodiment of the present invention includes an adhesive porous insulating layer formation unit, a stacking unit, and an adhering unit, and further includes another unit as appropriate.

<Adhesive Porous Insulating Layer Formation Step and Adhesive Porous Insulating layer Formation Unit>

### [Production Method of Porous Insulating Layer-Applied Material for Adhering Electrochemical Element Member]

The adhesive porous insulating layer formation step is a step of forming a first adhesive porous insulating layer on a first base material, and can be preferably implemented with an adhesive porous insulating layer formation unit.

The adhesive porous insulating layer formation unit is a unit that forms the first adhesive porous insulating layer on the first base material.

The first adhesive porous insulating layer is a porous structure having an co-continuous structure including a resin as a backbone; wherein the resin is a cross-linked resin; and wherein the first adhesive porous insulating layer gives a peel strength of 2 N/m or more in a peel measuring method with use of a peel strength measuring element derived by disposing the first adhesive porous insulating layer through each of one entire face of the first base material having a size of a 30 mm×100 mm and one entire face of the second base material having a size of a 30 mm×100 mm to provide first adhesive porous insulating layers, placing the first adhesive porous insulating layers to face each other, and performing thermal adhesion under conditions at a temperature of 140 °C and an air cylinder thrust of 500 N for 1 minute. The adhesive porous insulating layer formation step enables preferred production of the porous insulating layer-applied material for adhering an electrochemical element member according to an embodiment of the present invention as described above.

The adhesive porous insulating layer formation step includes an applying treatment to apply a liquid composition on the first base material, and a polymerization treatment to apply heat or light to the liquid composition to cause polymerization, and further includes another treatment as appropriate.

The adhesive porous insulating layer formation unit includes a storage container that contains the liquid composition, an applying part that applies the liquid composition contained in the storage container onto a base material, and a polymerization part that applies heat or light to the liquid composition to cause polymerization, and further includes another part as appropriate.

### —Liquid Composition—

The liquid composition contains a polymerizable compound and a liquid, and further contains another component such as a polymerization initiator as appropriate.

The liquid composition forms a porous resin, has a light transmittance of 30% or more at a wavelength of 550 nm measured with stirring the liquid composition, and has a percentage rise of 1.0% or more in haze value in a haze measuring element prepared by polymerizing the liquid composition.

The liquid composition forms a porous structure. In other words, polymerization and curing of a polymerizable compound in the liquid composition forms a resin structure having a porous structure including a resin as a backbone (also referred to as “porous resin” or “porous structure”).

When the peel strength of an insulating layer formed of the porous structure is 2 N/m or more, the insulating layer corresponds to an adhesive porous insulating layer in the porous insulating layer-applied material for adhering an electrochemical element member according to an embodiment of the present invention, and to the first adhesive porous insulating layer in the stack according to an embodiment of the present invention.

When the peel strength of an insulating layer of the porous structure is less than 2 N/m, the porous insulating layer corresponds to another porous insulating layer.

The term “the liquid composition forms a porous resin” is intended to encompass not only formation of a porous resin in the liquid composition, but also formation of a porous resin precursor (e.g., a backbone of a porous resin) in the liquid composition followed by formation of a porous resin by a subsequent treatment (e.g., heat treatment).

### —Polymerizable Compound—

The polymerizable compound forms a resin by polymerization, and constitutes a porous resin depending on composition and characteristics of the liquid composition.

The polymerizable compound is not particularly limited as long as it forms a polymerization product (resin) by polymerization. A known polymerizable compound can be appropriately selected corresponding to a purpose, but has preferably at least one radical polymerizable functional group.

Preferred examples of the polymerizable compound may include, but are not limited to, radical polymerizable compounds such as a monofunctional, bifunctional, or trifunctional or higher radical polymerizable monomer or radical polymerizable oligomer; functional monomers or functional oligomers further having a functional group other than polymerizable functional groups. In particular, bifunctional or higher radical-polymerizable compounds are preferred.

A polymerizable group of the polymerizable compound is preferably at least either of a (meth)acryloyl group or a vinyl group, and more preferably a (meth)acryloyl group.

The polymerizable compound is preferably polymerizable by emission of energy, and more preferably polymerizable by heat or light.

A resin formed from the polymerizable compound is preferably a resin having a network structure formed by application of active energy rays (e.g., light irradiation or heating). Preferred examples thereof include, but are not limited to, acrylate resins, methacrylate resins, urethane acrylate resins, vinyl ester resins, unsaturated polyester resins, epoxy resins, oxetane resins, vinyl ether resins, and resins formed by an ene-thiol reaction.

Particularly, in view of ease of forming a structure by use of radical polymerization with high reactivity, more preferred are resins formed from a polymerizable compound having a (meth)acryloyl group, such as acrylate resins, methacrylate resins, and urethane acrylate resins, and in view of productivity, also more preferred are resins formed of a polymerizable compound having a vinyl group, such as a vinyl ester resin.

Each of these may be used alone or in combination with others. When two or more resins are used in combination, combination of the polymerizable compound is not particularly limited and can be appropriately selected corresponding to a purpose. For example, a urethane acrylate resin is preferably mixed as a main component with other resins, for the purpose of imparting flexibility. A polymerizable compound having at least either of an acryloyl group or a methacryloyl group is referred to as a polymerizable compound having a (meth)acryloyl group.

The active energy rays are not particularly limited as long as they can impart energy necessary for proceeding with a polymerization reaction of a polymerizable compound in the liquid composition. Examples thereof include, but are not limited to, ultraviolet rays, electron beams, α-rays, β-rays, γ-rays, and X-rays. In particular, ultraviolet rays are preferred. Particularly when a high-energy light source is used, the polymerization reaction can proceed even without a polymerization initiator.

Examples of the monofunctional radical polymerizable compound may include, but are not limited to, 2-(2-ethoxyethoxy)ethyl acrylate, methoxy polyethylene glycol monoacrylate, methoxy polyethylene glycol monomethacrylate, phenoxy polyethylene glycol acrylate, 2-acryloyloxyethyl succinate, 2-ethylhexyl acrylate, 2-hydroxyethyl acrylate, 2-hydroxypropyl acrylate, tetrahydrofurfuryl acrylate, 2-ethylhexyl carbitol acrylate, 3-methoxybutyl acrylate, benzyl acrylate, cyclohexyl acrylate, isoamyl acrylate, isobutyl acrylate, methoxytriethylene glycol acrylate, phenoxytetraethylene glycol acrylate, cetyl acrylate, isostearyl acrylate, stearyl acrylate, and styrene monomer. Each of these may be used alone or in combination with others.

Examples of the bifunctional radical polymerizable compound may include, but are not limited to, 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, polyethylene glycol diacrylate, neopentyl glycol diacrylate, EO-modified bisphenol A diacrylate, EO-modified bisphenol F diacrylate, neopentyl glycol diacrylate, and tricyclodecanedimethanol diacrylate. Each of these may be used alone or in combination with others.

Examples of the trifunctional or higher radical polymerizable compound may include, but are not limited to, trimethylolpropane triacrylate (TMPTA), trimethylolpropane trimethacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate (PETTA), glycerol triacrylate, ECH-modified glycerol triacrylate, EO-modified glycerol triacrylate, PO-modified glycerol triacrylate, tris(acryloxyethyl)isocyanurate, dipentaerythritol hexaacrylate (DPHA), caprolactone-modified dipentaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylolpropane tetraacrylate (DTMPTA), pentaerythritol ethoxytetraacrylate, EO-modified phosphoric triacrylate, and 2,2,5,5-tetrahydroxymethylcyclopentanone tetraacrylate. Each of these may be used alone or in combination with others.

The content of the polymerizable compound is preferably 5.0% by mass or more to 70.0% by mass or less, more preferably 10.0% by mass or more to 50.0% by mass or less, and even more preferably 20.0% by mass or more to 40.0% by mass or less, based on the total amount of the liquid composition.

The content is preferably 70.0% by mass or more, because the void size of a resulting porous body is not too small with several nanometers or less, thus providing the porous body with appropriate porosity which avoids a tendency of poor permeation of liquids or gases. Meanwhile, the content is also preferably 5.0% by mass or more, because the resin forms a three-dimensional network structure enough to provide a porous structure sufficiently, and also exhibits a tendency to improve strength of the resulting porous structure.

### —Liquid—

The liquid contains a porogen, and contains another liquid other than porogen as appropriate. The porogen is a liquid that is compatible with a polymerizable compound and becomes incompatible (causes phase separation) with the resulting polymerization product (resin) in a process of polymerizing the polymerizable compound in the liquid composition. Presence of the porogen in the liquid composition causes formation of a porous resin upon polymerization of a polymerizable compound. The porogen can also preferably dissolve a compound that generates radical or an acid by light or heat (a polymerization initiator described later).

The liquid or porogen may be used alone or in combination with others.

In the embodiment, the liquid is not polymerizable.

The boiling point of a single type of or a combination of two or more types of the porogens is preferably 50 °C or higher to 250 °C or lower, more preferably 70 °C or higher to 200 °C or lower, and even more preferably 120 °C or more to 190 °C or less, at normal pressures. With a boiling point of 50 °C or higher, vaporization of the porogen is prevented at about room temperature to cause handling of the liquid composition to be easier, thus facilitating control of the content of the porogen in the liquid composition. Meanwhile, with a boiling point of 250 °C or lower, the time required for removing the porogen after polymerization is shortened, thus improving productivity of a porous resin. In addition, the amount of the porogen remaining inside a porous resin can be reduced, thus providing improved quality in use of the porous resin as a functional layer, such as a separation layer for separating a substance or a reaction layer to serve as a reaction field.

Examples of the porogen include, but are not limited to: ethylene glycols such as diethylene glycol monomethyl ether, ethylene glycol monobutyl ether, ethylene glycol monoisopropyl ether, and dipropylene glycol monomethyl ether; esters such as γ-butyrolactone and propylene carbonate; and amides such as N,N-dimethylacetamide. Examples thereof further include, but are not limited to, liquids having a relatively large molecular weight, such as methyl tetradecanoate, methyl decanoate, methyl myristate, and tetradecane. Examples thereof further include, but are not limited to, liquids such as acetone, 2-ethylhexanol, and 1-bromonaphthalene.

It should be noted that the liquids listed above do not always serve as the porogen.

As described above, the porogen is a liquid that is compatible with a polymerizable compound and becomes incompatible (causes phase separation) with the resulting polymerization product (resin) in a process of polymerizing the polymerizable compound in the liquid composition. In other words, whether or not a liquid serves as the porogen depends on a relation between a polymerizable compound and a resulting polymerization product (a resin formed by polymerization of the polymerizable compound).

The liquid composition preferably contains at least one type of porogen having the above-described specific relation with a polymerizable compound, thus providing a broader range of options of a material for preparing the liquid composition, and facilitating design of the liquid composition. The broader range of options of a material for preparing the liquid composition leads to a broader range of options in response to requirements for any characteristic of the liquid composition in a view other than formation of a porous structure.

For example, when the liquid composition is to be discharged by an inkjet mode, the liquid composition is required to have discharge stability as a required characteristic other than a capability of forming a porous structure, but the broader range of selection of a material facilitates design of the liquid composition.

The content of the liquid or porogen is preferably 30.0% by mass or more to 95.0% by mass or less, more preferably 50.0% by mass or more to 90.0% by mass or less, and even more preferably 60.0% by mass or more to 80.0% by mass or less, based on the total amount of the liquid composition.

The content of the liquid or porogen is preferably 30.0% by mass or more, because the void size of a resulting porous body is not too small with several nanometers or less, thus providing the porous body with appropriate porosity which avoids a tendency of poor permeation of liquids or gases. Meanwhile, the content of the liquid or porogen is also preferably 95.0% by mass or less, because the resin forms a three-dimensional network structure enough to provide a porous structure sufficiently, and also exhibits a tendency to improve strength of the resulting porous structure.

Since, as described above, the liquid composition only needs to contain at least one porogen having the above-described specific relation with a polymerizable compound, the liquid composition may additionally contain another liquid (non-porogen liquid) that does not have the above-described specific relation with the polymerizable compound.

The content of said another liquid is preferably 10.0% by mass or less, more preferably 5.0% by mass or less, even more preferably 1.0% by mass or less, and particularly preferably 0% by mass (not containing), based on the total amount of the liquid composition.

The mass ratio of a polymerizable compound and a porogen (polymerizable compound:porogen) in the liquid composition is preferably 1.0:0.4 to 1.0:19.0, more preferably 1.0:1.0 to 1.0:9.0, and even more preferably 1.0:1.5 to 1.0:4.0.

### —Other Components—

### —Polymerization Initiator—

The liquid composition may contain another component such as a polymerization initiator. The polymerization initiator is a material that can generate active species such as radicals and cations by energy such as light or heat to cause polymerization of a polymerizable compound. Examples of the polymerization initiator include, but are not limited to, known radical polymerization initiators, cation polymerization initiators, and base generators. Each of these may be used alone or in combination with others. In particular, a radical photopolymerization initiator is preferred.

The radical photopolymerization initiator is not particularly limited and a known radical photopolymerization initiator can be appropriately selected corresponding to a purpose. Examples thereof include, but are not limited to, radical photopolymerization initiators such as Michler's ketone and benzophenone known by the trade names IRGACURE and DAROCUR.

Specific examples thereof may include, but are not limited to, α-hydroxy-acetophenone, α-aminoacetophenone, 4-aroyl-1,3-dioxolane, benzyl ketal, 2,2-diethoxyacetophenone, p-dimethylaminoacetophene, p-dimethylaminopropiophenone, benzophenone, 2-chlorobenzophenone, pp′-dichlorobenzophene, pp′-bis-diethylaminobenzophenone, Michler's ketone, benzyl, benzoin, benzyl dimethyl ketal, tetramethylthiuram monosulphide, thioxanthone, 2-chlorothioxanthone, 2-methylthioxanthone, azobisisobutyronitrile, benzoin peroxide, di-tert-butyl peroxide, 1-hydroxycyclohexylphenyl ketone, 2-hydroxy-2-methyl-1-phenyl-1-one, 1-(4-isopropylphenyl)-2-hydroxy-2-methylpropan-1-one, methylbenzoylformate, benzoin isopropyl ether, benzoin methyl ether, benzoin ethyl ether, benzoin ether, benzoin isobutyl ether, benzoin n-butyl ether, benzoin n-propyl, 1-hydroxy-cyclohexyl-phenyl-ketone, 2-benzyl-2-dimethylamino-1-(4-morpholinophenyl)-butanone-1,1-hydroxy-cyclohexyl-phenyl-ketone, 2,2-dimethoxy-1,2-diphenylethane-1-one, bis(η5-2,4-cyclopentadiene-1-yl)-bis(2,6-difluoro-3-(1H-pyrrol-1-yl)-phenyl) titanium, bis(2,4,6-trimethylbenzoyl)-phenylphosphine oxide, 2-methyl-1[4-(methylthio)phenyl]-2-morfolinopropan-1-one, 2-hydroxy-2-methyl-1-phenyl-propane-1-one (DAROCUR 1173), bis(2,6-dimethoxybenzoyl)-2,4,4-trimethyl-pentylphosphine oxide, 1-[4-(2-hydroxyethoxy)-phenyl]-2-hydroxy-2-methyl-1-propane-1-one monoacylphosphine oxide, and bisacylphosphine oxide; titanocene, fluoresceine, anthraquinone, and thioxanthone; xanthone, lophine dimer, and trihalomethyl compounds; and dihalomethyl compounds, active ester compounds, and organoboron compounds.

Furthermore, a photo-cross-linkable radical generator such as a bisazide compound may be used in combination. In polymerization only by heat, a thermal polymerization initiator such as azobisisobutyronitrile (AIBN), which is a typical radical generator, can be used.

For a sufficient curing rate, the content of the polymerization initiator is preferably 0.05% by mass or more to 10.0% by mass or less, and more preferably 0.5% by mass or more to 5.0% by mass or less, based on the total mass of the polymerizable compound as 100.0% by mass.

The liquid composition may be a non-dispersive composition containing no dispersion in the liquid composition, or a dispersive composition containing a dispersion in the liquid composition, but is preferably a non-dispersive composition.

### [Polymerization-Induced Phase Separation]

A porous resin is formed by polymerization-induced phase separation. Polymerization-induced phase separation refers to a state in which a porogen is compatible with a polymerizable compound but becomes incompatible (generates phase separation) with the resulting polymerization product (resin) in a process of polymerizing the polymerizable compound. Although several other methods can provide a porous body by phase separation, use of a polymerization-induced phase separation method allows formation of a porous body having a network structure and thus has a promising feature of producing a porous body with high resistance to chemicals and heat. Polymerization-induced phase separation also has advantages such as shorter process time and easier surface modification relative to other methods.

Next, description will be made for a process for forming a porous resin using polymerization-induced phase separation with the liquid composition containing a polymerizable compound. The polymerizable compound undergoes a polymerization reaction by light irradiation or the like to form a resin. During this process, solubility of a porogen in the growing resin decreases to cause phase separation between the resin and the porogen. Finally, the resin forms a porous structure that includes pores filled with the porogen and the like and has an co-continuous structure build up with a resin backbone. Then, upon drying, the porogen and the like are removed, thereby leaving a porous resin having an co-continuous structure of a three-dimensional network structure. Thus, in order to form a porous resin having appropriate porosity, investigations are made for compatibility of a porogen with a polymerizable compound and compatibility of a porogen with a resin formed by polymerization of a polymerizable compound.

### [Light Transmittance]

The light transmittance at a wavelength of 550 nm measured with stirring the liquid composition is 30% or more.

Compatibility between a porogen and a polymerizable compound can be determined by the light transmittance.

A light transmittance of 30% or more is determined as indicating presence of a porogen in a liquid and compatibility between a polymerizable compound and the porogen, and less than 30% is determined as indicating incompatibility between a polymerizable compound and a liquid.

The light transmittance can be measured particularly by the method as follows.

First, a liquid composition is injected into a quartz cell, and the transmittance of light (visible light) at a wavelength of 550 nm of the liquid composition is measured with stirring the liquid composition using a stirrer at 300 rpm.
Quartz cell: special microcell with a screw cap (trade name: M25-UV-2, manufactured by GL Sciences Ltd.).
Transmittance measuring instrument: USB 4000, manufactured by Ocean Optics, Inc.
Stirring speed: 300 rpm.
Measurement wavelength: 550 nm.
Reference: light transmittance at a wavelength of 550 nm measured and acquired with the quartz cell filled with the air (transmittance: 100%).

### [Percentage Rise of Haze Value]

The percentage rise of a haze value in a haze measuring element prepared by polymerization of the liquid composition is 1.0% or more.

Compatibility between a porogen and a resin formed by polymerization of a polymerizable compound can be determined by the percentage rise of the haze value.

A percentage rise of the haze value of 1.0% or more is determined as indicating presence of a porogen in a liquid and incompatibility between a resin and a porogen, and less than 1.0% is determined as indicating compatibility between a resin and a liquid.

The haze value in a haze measuring element is higher as compatibility between a resin formed by polymerization of a polymerizable compound and a porogen is lower; the haze value is lower as the compatibility is higher. In addition, a higher haze value indicates that a resin formed by polymerization of a polymerizable compound is more likely to form a porous structure.

The percentage rise of the haze value particularly represents a percentage rise of the haze value between before and after polymerization of a haze measuring element having an average thickness of 100 μm prepared by polymerization of the liquid composition, and can be measured by the following method.

### —Preparation of Haze Measuring Element—

First, resin microparticles are uniformly dispersed as a gap agent on a non-alkali glass substrate by spin coating. Subsequently, the substrate having the gap agent applied thereon and another non-alkali glass substrate having no gap agent applied thereon are adhered together so as to insert a surface coated with the gap agent. Then, the liquid composition is filled in a space between the adhered substrates by utilizing a capillary phenomenon, thereby producing a “pre-UV irradiation haze measuring element”. Subsequently, the pre-UV irradiation haze measuring element is irradiated with UV to cure the liquid composition. Finally, the periphery of the substrate is sealed with a sealing agent, thereby producing a “haze measuring element”. The size of the gap agent (an average particle diameter of 100 μm) corresponds to the average thickness of the haze measuring element. Various production conditions are described below.
Non-alkali glass substrate: OA-10G, manufactured by Nippon Electric Glass Co., Ltd., 40 mm, t=0.7 mm.
Gap agent: resin microparticles MICROPEARL GS-L100, having an average particle diameter of 100 μm, manufactured by Sekisui Chemical Co., Ltd.
Spin coating conditions: at a dispersion droplets volume of 150 μL, a rotation speed of 1000 rpm, and a rotation time of 30 seconds.
Amount of liquid composition filled: 160 μL.
UV irradiation conditions: using UV-LED as a light source at a light source wavelength of 365 nm and an irradiation intensity of 30 mW/cm² for an irradiation time of 20 seconds.
Sealing agent: TB3035B (manufactured by ThreeBond Holdings Co., Ltd.).

### —Measurement of Haze Value (Cloudiness)—

Next, the haze values (cloudiness) of the pre-UV irradiation haze measuring element and haze measuring element thus prepared are measured. A measured value in the pre-UV irradiation haze measuring element is set as a reference (haze value 0), and the percentage rise of a measured value (haze value) in the haze measuring element to a measured value in the pre-UV irradiation haze measuring element is calculated.

An instrument used for the measurement is as follows.
Haze measuring apparatus: hazemeter NDH5000, manufactured by Nippon Denshoku Industries Co., Ltd.

### [Viscosity]

In view of workability in supply of the liquid composition, and thus, at 25 °C, the viscosity of the liquid composition is preferably 1.0 mPa·s or more to 150.0 mPa·s or less, more preferably 1.0 mPa·s or more to 30.0 mPa·s or less, particularly preferably 1.0 mPa·s or more to 25.0 mPa·s or less. With providing the liquid composition with a viscosity of 1.0 mPa·s or more to 30.0 mPa·s or less, use of the liquid composition in an inkjet mode also brings about good discharge. The viscosity thereof can be measured using e.g., a viscometer (product name: RE-550L, manufactured by Toki Sangyo Co., Ltd.).

### [Hansen Solubility Parameter (HSP)]

The compatibility between a porogen and a polymerizable compound, and the compatibility between a porogen and a resin formed by polymerization of a polymerizable compound, which are described above, can be estimated through Hansen solubility parameter (HSP). Hansen solubility parameter (HSP) is a useful tool for estimating compatibility between two substances and is a parameter discovered by Charles M. Hansen. Hansen solubility parameter (HSP) is expressed by combining the following three parameters (δD, δP, and δH) derived experimentally and theoretically. The unit of Hansen solubility parameter (HSP) is MPa^{0.5} or (J/cm³)^{0.5}. In the embodiment, (J/cm³)^{0.5} is used.
δD: energy derived from the London dispersion force.
δP: energy derived from a dipole-dipole interaction.
δH: energy derived from a hydrogen bonding force.

Hansen solubility parameter (HSP) is a vector quantity expressed as (δD, δP, δH), and is indicated by plotting on a three-dimensional space (Hansen space) having the three parameters as coordinate axes. The Hansen solubility parameters (HSPs) of commonly used substances are available from known information sources such as databases; for example, the Hansen solubility parameter (HSP) of a certain substance can be obtained by referring to a database. For a substance having a Hansen solubility parameter (HSP) unregistered in a database, the Hansen solubility parameter (HSP) can be calculated from a chemical structure of the substance or by the Hansen solubility sphere method (to be described later) by using a computer software program such as Hansen Solubility Parameters in Practice (HSPiP).

The Hansen solubility parameter (HSP) of a mixture of two or more substances is calculated as a vector sum of values each obtained by multiplying the Hansen solubility parameter (HSP) of each substance by the volume ratio of each substance to the entire mixture. In the present disclosure, the Hansen solubility parameter (HSP) of a liquid (porogen) obtained based on a known information source such as a database is referred to as the “Hansen solubility parameter of the liquid”.

Relative energy difference (RED) based on the Hansen solubility parameter (HSP) of a solute and the Hansen solubility parameter (HSP) of a solution is represented by the following formula.

$$\begin{matrix}[ Formula 1 ] & \\ Relative energy difference ( RED ) = \frac{Ra}{Ro} & ( Formula 1 )\end{matrix}$$

In the above formula, Ra represents an interaction distance between the Hansen solubility parameter (HSP) of the solute and the Hansen solubility parameter (HSP) of the solution, and Ro represents an interaction radius of the solute. The interaction distance (Ra) between the Hansen solubility parameters (HSPs) indicates the distance between the two substances. A smaller value of the distance represents that the two substances are present closer to each other in a three-dimensional space (Hansen space), and that they are more likely to dissolve (be compatible with) each other.

Assuming that the respective Hansen solubility parameters (HSPs) for the two substances (a solute A and a solution B) are as follows, Ra can be calculated as follows:

HSP^{A}=(δD^{A},δP^{A},δH^{A})

HSP^{B}=(δD^{B},δP^{B},δH^{B})

Ra=[4×(δD^{A}−δD^{B})²+(δP^{A}−P^{B})²+(δH^{A}−δH^{B})²]^{1/2}

Ro (interaction radius of the solute) can be determined by, e.g., the Hansen solubility sphere method described below.

### —Hansen Solubility Sphere Method—

First, a target substance having Ro to be determined and several tens of evaluation liquids having known Hansen solubility parameters (HSPs) (liquids semantically distinguished from the “liquid (porogen)”) are prepared, and a compatibility test of the target substance is performed for each evaluation liquid. In the compatibility test, the Hansen solubility parameters (HSPs) of evaluation liquids exhibiting compatibility and the Hansen solubility parameters (HSPs) of evaluation liquids exhibiting no compatibility are each plotted on the Hansen space. On the basis the plotted Hansen solubility parameters (HSPs) of each of the evaluation liquids, a virtual spherical body (Hansen sphere) including the Hansen solubility parameters (HSPs) of the evaluation liquids exhibiting compatibility but not including the Hansen solubility parameters (HSPs) of the evaluation liquids exhibiting no compatibility is created in the Hansen space. The radius of the Hansen sphere represents the interaction radius Ro of the substance, and the center of the Hansen sphere represents the Hansen solubility parameter (HSP) of the substance. It should be noted that an evaluator sets by himself/herself an evaluation criteria for compatibility of the target substance having an interaction radius Ro and a Hansen solubility parameter (HSP) to be determined with each evaluation liquid having a known Hansen solubility parameter (HSP) (a determination criteria for presence of intercompatibility). The evaluation criteria in the present disclosure are described later.

### —Hansen Solubility Parameter (HSP) and Interaction Radius of Polymerizable Compound—

The Hansen solubility parameter (HSP) of a polymerizable compound and the interaction radius of a polymerizable compound in the present disclosure are determined by the Hansen solubility sphere method. As an evaluation criteria for compatibility in the Hansen solubility sphere method are set by an evaluator himself/herself as described above, the Hansen solubility parameter (HSP) and the interaction radius of a polymerizable compound obtained based on the following criteria are represented by “Hansen solubility parameter C of a polymerizable compound” and “interaction radius D of a polymerizable compound”, respectively. In other words, the “Hansen solubility parameter C of a polymerizable compound” and the “interaction radius D of a polymerizable compound” are obtained based on the Hansen solubility sphere method involving an evaluation criteria for the compatibility set by the evaluator himself/herself, unlike the “Hansen solubility parameter of a liquid” obtained based on a known information source such as a database.

The Hansen solubility parameter C of a polymerizable compound and the interaction radius D of a polymerizable compound can be derived by evaluating compatibility of a polymerizable compound with an evaluation liquid (evaluation based on “light transmittance at a wavelength of 550 nm of a transmittance measuring composition containing a polymerizable compound and an evaluation liquid, measured along with stirring the transmittance measuring composition”) in accordance with the following [1-1] and the method of measuring light transmittance as described below.

### [1-1] Preparation of Transmittance Measuring Composition

First, a polymerizable compound having a Hansen solubility parameter (HSP) to be determined and several tens of evaluation liquids having known Hansen solubility parameters (HSPs) are prepared, and the polymerizable compound, each of the evaluation liquids, and a polymerization initiator are mixed at the following ratio to prepare a transmittance measuring composition. As the several tens of evaluation liquids having known Hansen solubility parameters (HSPs), the following 21 species of evaluation liquids are used.

### —Ratio of Transmittance Measuring Composition—

Polymerizable compound having a Hansen solubility parameter (HSP) to be determined: 28.0% by mass.
Evaluation liquid having a known Hansen solubility parameter (HSP): 70.0% by mass.
Polymerization initiator (IRGACURE 819, manufactured by BASF SE): 2.0% by mass.

### —Group of Evaluation Liquids (21 Species)—

Ethanol, 2-propanol, mesitylene, dipropylene glycol monomethyl ether, N-methyl 2-pyrrolidone, γ-butyrolactone, propylene glycol monomethyl ether, propylene carbonate, ethyl acetate, tetrahydrofuran, acetone, n-tetradecane, ethylene glycol, diethylene glycol monobutyl ether, diethylene glycol butyl ether acetate, methyl ethyl ketone, methyl isobutyl ketone, 2-ethyl hexanol, diisobutyl ketone, benzyl alcohol, 1-bromonaphthalene.

### Hansen Solubility Parameter (HSP) and Interaction Radius of Resin Formed by Polymerization of Polymerizable Compound—

The Hansen solubility parameter (HSP) of a resin formed by polymerization of a polymerizable compound and the interaction radius of a resin formed by polymerization of a polymerizable compound are determined by the Hansen solubility sphere method. As an evaluation criteria for compatibility in the Hansen solubility sphere method are set by an evaluator himself/herself as described above, the Hansen solubility parameter (HSP) and the interaction radius of a resin formed by polymerization of a polymerizable compound obtained based on the following criteria are represented by “Hansen solubility parameter A of a resin” and “interaction radius B of a resin”, respectively. In other words, the “Hansen solubility parameter A of a resin” and the “interaction radius B of a resin” are obtained based on the Hansen solubility sphere method involving an evaluation criteria for the compatibility set by the evaluator himself/herself, unlike the “Hansen solubility parameter of a liquid” obtained based on a known information source such as a database.

The Hansen solubility parameter A of a resin and the interaction radius B of a resin can be derived by evaluating compatibility of a resin with an evaluation liquid (evaluation based on “percentage rise of a haze value (cloudiness) in a haze measuring element made of a haze measuring composition containing a polymerizable compound and an evaluation liquid”) in accordance with the following [2-1] and the method of measuring percentage rise of a haze value as described below.

### [2-1] Preparation of Haze Measuring Composition

First, a resin precursor (polymerizable compound) having a Hansen solubility parameter (HSP) to be determined and several tens of evaluation liquids having known Hansen solubility parameters (HSPs) are prepared, and the polymerizable compound, each of the evaluation liquids, and a polymerization initiator are mixed at the following ratio to prepare a haze measuring composition. As the several tens of evaluation liquids having known Hansen solubility parameters (HSPs), the following 21 species of evaluation liquids are used.

### —Ratio of Haze Measuring Composition—

Resin precursor (polymerizable compound) having a Hansen solubility parameter (HSP) to be determined: 28.0% by mass.
Evaluation liquid having a known Hansen solubility parameter (HSP): 70.0% by mass.
Polymerization initiator (IRGACURE 819, manufactured by BASF SE): 2.0% by mass.

### —Group of Evaluation Liquids (21 Species)—

Ethanol, 2-propanol, mesitylene, dipropylene glycol monomethyl ether, N-methyl 2-pyrrolidone, γ-butyrolactone, propylene glycol monomethyl ether, propylene carbonate, ethyl acetate, tetrahydrofuran, acetone, n-tetradecane, ethylene glycol, diethylene glycol monobutyl ether, diethylene glycol butyl ether acetate, methyl ethyl ketone, methyl isobutyl ketone, 2-ethyl hexanol, diisobutyl ketone, benzyl alcohol, 1-bromonaphthalene.

### —Relative Energy Difference (RED) Based on Hansen Solubility Parameters (HSPs) of Resin and Liquid (Porogen)—

A relative energy difference (RED) is calculated based on the following Formula 2, from the Hansen solubility parameter A of a resin formed by polymerization of a polymerizable compound, the interaction radius B of the resin, and the Hansen solubility parameter of a porogen, all of which are determined based on percentage rise of a haze value of a haze measuring element made of a haze measuring composition containing the polymerizable compound and an evaluation liquid as described above. The relative energy difference (RED) is preferably 1.00 or more, more preferably 1.10 or more, still more preferably 1.20 or more, and particularly preferably 1.30 or more.

$$\begin{matrix}[ Formula 2 ] & \\ & ( Formula 2 )\end{matrix}$$

$$Relative energy difference ( RED ) = \frac{\begin{matrix}Distance between “ Hansen solubility \\ parameter A of resin ” and “ Hansen \\ solubility parameter of solvent ”\end{matrix}}{“ interaction radius B of resin ”}$$

The relative energy difference (RED) determined based on the Hansen solubility parameters (HSPs) of the resin and the porogen is preferably 1.00 or more, because the porogen and the resin, which is formed by polymerization of the polymerizable compound in the liquid composition, are likely to cause phase separation, thus being more likely to form a porous resin.

### —Relative Energy Difference (RED) Based on Hansen Solubility Parameters (HSPs) of Polymerizable Compound and Liquid (Porogen)—

A relative energy difference (RED) is calculated based on the following Formula 3, from the Hansen solubility parameter C of a polymerizable compound determined based on the light transmittance at a wavelength of 550 nm of a transmittance measuring composition containing the polymerizable compound and an evaluation liquid measured along with stirring the transmittance measuring composition, the interaction radius D of the polymerizable compound determined based on compatibility of the polymerizable compound with the evaluation liquid, and the Hansen solubility parameter of the liquid as described above. The relative energy difference (RED) is preferably 1.05 or less, more preferably 0.90 or less, still more preferably 0.80 or less, and particularly preferably 0.70 or less.

$$\begin{matrix}[ Formula 3 ] & \\ & ( Formula 3 )\end{matrix}$$

$$Relative energy difference ( RED ) = \frac{\begin{matrix}Distance between “ Hansen solubility parameter \\ C of polymerizable compound ” and “ Hansen \\ solubility parameter of solvent ”\end{matrix}}{“ interaction radius D of polymerizable compound ”}$$

When the relative energy difference (RED) determined based on the Hansen solubility parameters (HSPs) of the polymerizable compound and the porogen is 1.05 or less, the polymerizable compound and the porogen tend to exhibit compatibility with each other: as RED comes closer to 0, the compatibility is more exhibited. Therefore, when the relative energy difference (RED) is 1.05 or less, the liquid composition exhibits high dissolution stability such that the polymerizable compound does not precipitate over time after dissolved in the porogen. Since high solubility of the polymerizable compound in the porogen allows retention of discharge stability of the liquid composition, the liquid composition in the embodiment can be preferably also applied to, e.g., a mode of discharging the liquid composition such as an inkjet mode. Meanwhile, with a relative energy difference (RED) of 1.05 or less, separation of the polymerizable compound and the porogen is prevented in the liquid composition before initiation of a polymerization reaction, thus avoiding irregular or heterogenous formation of a porous resin.

### [Method for Producing Liquid Composition]

A method of producing the liquid composition is not particularly limited and can be appropriately selected corresponding to a purpose. However, the liquid composition is preferably produced via a step of dissolving a polymerization initiator in a polymerizable compound, a step of further dissolving a porogen and other components, a step of stirring for providing a homogeneous solution, etc.

### «Storage Container»

The storage container includes the liquid composition and a container, and the container contains the liquid composition.

Examples of the container include, but are not limited to, glass bottles, plastic containers, plastic bottles, stainless steel bottles, 18-litter drums, and drum cans.

### «Applying Treatment and Applying Part»

The applying treatment is a treatment to apply the liquid composition contained in the storage container onto a base material, and can be preferably performed by an applying part.

The discharge part is a part to apply the liquid composition onto a base material.

The applying treatment and the applying part are not particularly limited as long as it can apply the liquid composition. Any applying device can be used corresponding to various applying methods such as spin coating, casting, micro gravure coating, gravure coating, bar coating, roll coating, wire bar coating, dip coating, slit coating, capillary coating, spray coating, nozzle coating, or a printing method such as gravure printing, screen printing, flexographic printing, offset printing, reverse printing, or inkjet printing. In particular, inkjet printing is preferred.

### «Polymerization Treatment and Polymerization Part»

The polymerization treatment is a treatment to apply heat or light to the liquid composition to cause polymerization, and can be preferably implemented with a polymerization part.

The polymerization part is a part to apply heat or light to the liquid composition to cause polymerization.

The polymerization results in polymerization of the polymer compound in the liquid composition, and polymerization-induced phase separation leads to formation of a porous resin, thereby enabling production of a stack including a base material and a porous resin on the base material.

The polymerization treatment and the polymerization part are not particularly limited and can be appropriately selected corresponding to a polymerization initiator, a manner of polymerization, etc. to be used. Examples thereof in photopolymerization include, but are not limited to, a light irradiation treatment and a light irradiation method with ultraviolet irradiation at a wavelength of 365 nm for 3 seconds, and examples thereof in heat polymerization include, but are not limited to, a heat treatment and a heating method with heating at 150 °C in vacuum drying for 12 hours.

### «Another Treatment and Another Part»

Another treatment in a production apparatus for the stack is not particularly limited and can be appropriately selected corresponding to a purpose as long as it does not impair an effect of the present invention, and example thereof include a removal treatment.

Another part in a method of producing the stack is not particularly limited and can be appropriately selected corresponding to a purpose as long as it does not impair an effect of the present invention, and example thereof include a removal part.

### «<Removal Treatment and Removal Part>»

The removal treatment is a treatment to remove a liquid from a porous resin formed by polymerization of the liquid composition by the polymerization treatment, and can be preferably implemented by a removal part.

The removal part is a part to remove a liquid from a porous resin formed by polymerization of the liquid composition by the polymerization part.

A method of removing the liquid is not particularly limited, and examples thereof include, but are not limited to, a method of removing a liquid such as a solvent and a liquid dispersion from a porous resin by heating. Such a method is preferred because at that time, heating under reduced pressure facilitates more removal of a liquid, thus reducing a residual liquid in an insulating layer thus formed.

### <Stacking Step and Stacking Unit>

The stacking step is a step of stacking the first base material having the first adhesive porous insulating layer formed thereon, and a second base material, so as to cause the first adhesive porous insulating layer to face the second base material, and can be preferably implemented with a stacking unit.

The stacking unit is a unit to stack the first base material having the first adhesive porous insulating layer formed thereon, and a second base material, so as to cause the first adhesive porous insulating layer to face the second base material.

In an aspect, the first base material may be an electrode, and the second base material may be a film separator. In another aspect, the first base material may be an electrode, and the second base material may be an electrode. Any of the aspects can be preferably employed. An electrode having an adhesive porous insulating layer formed may be present on an electrode base, or on an electrode composite layer disposed on an electrode base.

### <Adhering Step and Adhering Unit>

The adhering step is a step of adhering the first base material thus stacked, and a second base material via the first adhesive porous insulating layer, and can be preferably implemented with an adhering unit.

The adhering unit is a unit to adhere the first base material thus stacked, and a second base material via the first adhesive porous insulating layer.

Examples of a method of the adhering include, but are not limited to, a method of performing thermal adhesion under conditions at a temperature of 50 °C or more to 300 °C or less and an air cylinder thrust of 50 N or more to 1,000 N or less for 0.5 seconds or more to 10 seconds or less.

The unit of adhering is not particularly limited and can be appropriately selected corresponding to a purpose. Examples thereof include a hot plate sealer (manufactured by Ishizaki Electric MFG. Co., Ltd.).

[Embodiment that Forms Adhesive Porous Insulating Layer or Stack by Direct Supply of Liquid Composition to Base Material]

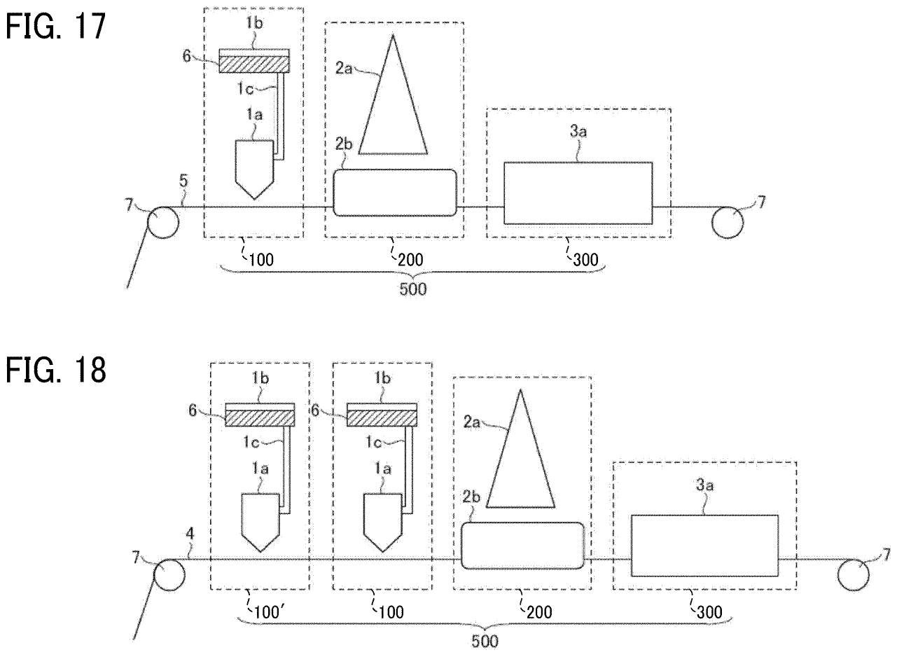

FIG. 17 is a schematic view illustrating an example of a production apparatus (liquid discharge apparatus) for an adhesive porous insulating layer for achieving a method of producing a porous insulating layer-applied material for adhering an electrochemical element member or a stack according to the embodiment.

A production apparatus 500 for an adhesive porous insulating layer is an apparatus that produces an adhesive porous insulating layer using the liquid composition described above. The production apparatus for adhesive porous insulating layer includes a printing part 100 that performs an applying treatment to apply the liquid composition onto a printing base material 4 to form a liquid composition layer, a polymerization part 200 that performs a polymerization treatment to apply heat or light to the liquid composition layer to cause polymerization, and a removal part 300 that performs a removal treatment to heat a porous resin precursor 6 in which a solvent is thus removed from a pore, thereby providing a porous resin. The production apparatus for an adhesive porous insulating layer includes a conveyor part 5 that conveys the printing base material 4, and the conveyor part 5 conveys the printing base material 4 at a preset speed in order of the printing part 100, the polymerization part 200, and the removal part 300.

### —Printing Part 100—

The printing part 100 includes a printing device 1a that represents an example of an application unit to achieve an applying step to apply a liquid composition for forming an adhesive porous insulating layer on the printing base material 4, a storage container 1b to contain the liquid composition, and a supply tube 1c to supply the liquid composition reserved in the storage container 1b to the printing device 1a.

The storage container 1b contains a liquid composition 7, and the printing part 100 discharges the liquid composition 7 from the printing device 1a to apply the liquid composition 7 onto the printing base material 4 to form a liquid composition layer as a thin film. The storage container 1b may have a configuration integrated with a production apparatus for a stack, or a configuration removable from a production apparatus for a stack. The storage container 1b may also be a container used for addition into a storage container integrated with a production apparatus for a stack, a storage container removable from a production apparatus for a stack, or another storage container.

The storage container 1b, the supply tube 1c, or another component can be freely selected as long as it can stably store and supply the liquid composition 7. A material to form the storage container 1b, the supply tube 1c, or another component preferably has a light-blocking property against an ultraviolet to relatively short wavelength visible region. This prevents the liquid composition 7 from initiating polymerization due to outside light.

### —Polymerization Part 200—

As shown in FIG. 17, in photopolymerization, the polymerization part 200 includes a light irradiation device 2a, which is an exemplary polymerization unit to perform a polymerization step, and a polymerization inert gas circulating device 2b, which circulates polymerization inert gas. The light irradiation device 2a irradiates light in presence of polymerization inert gas onto the liquid composition layer formed by the printing part 100, and causes photopolymerization to provide the porous resin precursor 6.

The light irradiation device 2a is appropriately selected corresponding to absorption wavelength of a photopolymerization initiator contained in the liquid composition layer, and is not particularly limited as long as it can initiate and proceed with polymerization of a compound in the liquid composition layer. Examples thereof include UV light sources such as high-pressure mercury lamps, metal halide lamps, hot-cathode tubes, cold-cathode tubes, and LEDs. Since, in general, shorter-wavelength light tends to penetrate more deeply with ease, a light source is preferably selected corresponding to the thickness of a porous membrane to be formed.

Moreover, in regard to irradiation strength of a light source in the light irradiation device 2a, too much of irradiation strength causes rapid progress of polymerization before sufficient phase separation, and thus tends to be less likely to provide a porous structure. On the other hand, too little of irradiation strength causes phase separation to progress in or beyond microscale, and leads to heterogeneity in and coarsening of multipores. This also results in long irradiation time and reduced productivity. Accordingly, the irradiation strength is preferably 10 mW/cm² or more to 1 W/cm2 or less, and more preferably 30 mW/cm² or more to 300 mW/cm² or less.

The polymerization inert gas circulating device 2b serves to reduce the concentration of polymerization active oxygen in the atmosphere, and to proceed with a polymerization reaction of a polymerizable compound close to a surface of the liquid composition layer without inhibition of the reaction. Polymerization inert gas used here is thus not particularly limited as long as it meets the aforementioned function, and examples thereof include nitrogen, carbon dioxide, and argon.

The O₂ concentration in polymerization inert gas is preferably less than 20% (an environment with less oxygen concentration than in the atmosphere), more preferably 0% or more to 15% or less, even more preferably 0% or more to 5% or less, in view of effectively providing an effect to reduce the inhibition. Furthermore, the polymerization inert gas circulating device 2b preferably includes a thermoregulation unit that allows regulation of temperature in order to achieve a condition for stable progress of polymerization.

In thermal polymerization, the polymerization part 200 may be a heating device. The heating device is not particularly limited and can be appropriately selected corresponding to a purpose. Examples thereof include substrate heating (e.g., hot plates), IR heaters, and warm air heaters, and these may be combined.

Heating temperature or time, or conditions of light irradiation can be appropriately selected corresponding to a polymerizable compound contained in the liquid composition 7, the thickness of a film thus formed, etc.

### —Removal Part 300—

As shown in FIG. 17, the removal part 300 has a heating device 3a, and performs a liquid removal step to heat with the heating device 3a, the porous resin precursor 6 formed by the polymerization part 200, thereby drying and removing a residual liquid. This allows formation of a porous resin. The removal part 300 may perform liquid removal under reduced pressure. The removal part 300 also conducts a polymerization promotion step to heat the porous membrane precursor 6 with the heating device 3a to further promote the polymerization reaction performed in the polymerization part 200, and an initiator removal step to heat, dry and remove with the heating device 3a, a photopolymerization initiator remaining in the porous membrane precursor 6. These polymerization promotion step and initiator removal step may be performed before or after the liquid removal step rather than simultaneously with the liquid removal step.

The removal part 300 further performs a polymerization completion step to heat multipores under reduced pressure after the liquid removal step. The heating device 3a is not particularly limited as long as it meets the aforementioned function, and examples thereof include IR heaters and warm air heaters.

Heating temperature or time can be appropriately selected corresponding to the boiling point of a liquid contained in the porous membrane precursor 6, the thickness of a film thus formed, etc.

Furthermore, as shown in FIG. 18, the production apparatus for an adhesive porous insulating layer in FIG. 17 may further have an additional printing part 100′. The production apparatus for an adhesive porous insulating layer in FIG. 18 has not only the printing part 100 to apply a liquid composition for forming an adhesive porous insulating layer on the printing base material 4, but also the additional printing part 100′ to apply a liquid composition for forming a porous insulating layer on the printing base material 4. Separate application of different liquid compositions onto a plurality of areas in the printing base material 4 enables the polymerization part 200 and the removal part 300 to form an adhesive porous insulating layer and a porous insulating layer, respectively.

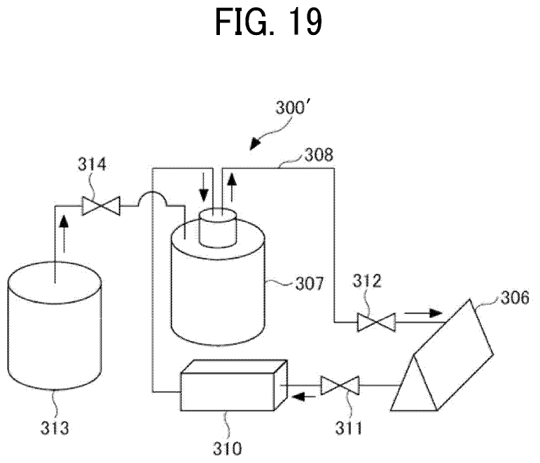

FIG. 19 is a schematic view illustrating another exemplary production apparatus (liquid discharge apparatus) for an adhesive porous insulating layer for achieving a method of producing a porous insulating layer-applied material for adhering an electrochemical element member, or a stack according to the embodiment.

A liquid discharge apparatus 300′ regulates a pump 310, and valves 311 and 312, and thereby enables a liquid composition to circulate through a liquid discharge head 306, a tank 307, and a tube 308.

The liquid discharge apparatus 300′ also includes an external tank 313, and upon decrease in a liquid composition in the tank 307, also enables supply of the liquid composition from the external tank 313 to the tank 307 by regulating the pump 310, the valves 311, 312, and 314. Use of the production apparatus for an adhesive porous insulating layer allows discharge of a liquid composition to a targeted site on a material to be applied.

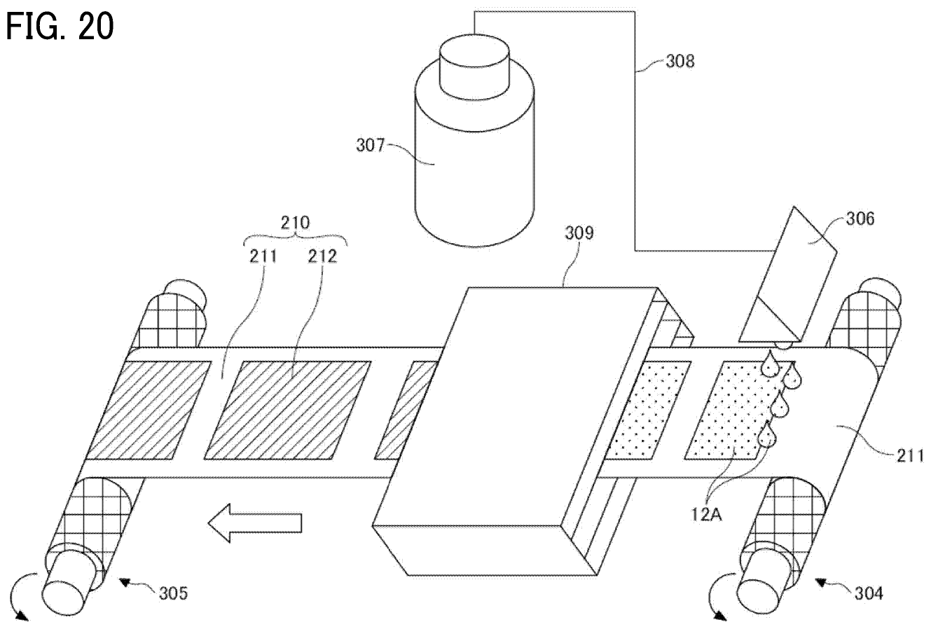

FIG. 20 illustrates another exemplary method of producing an adhesive porous insulating layer or a stack according to the embodiment.

A method of producing an applied material 210 having an adhesive porous resin applied onto a base material includes a step of serially discharging a liquid composition 12A onto a base material 211 using the liquid discharge apparatus 300′.

First, an elongated base material 211 is prepared. Then, the base material 211 is wound around a cylindrical core and set on a delivery roller 304 and a wind-up roller 305 so as to expose upward one side that is to form an adhesive porous resin 212, in FIG. 20. At that time, the delivery roller 304 and the wind-up roller 305 rotate counterclockwise, and the base material 211 is conveyed from right to left in FIG. 20. Then, the liquid discharge head 306 over the base material 211 and between the delivery roller 304 and the wind-up roller 305 discharges droplets of the liquid composition 12A onto the base material 211 serially conveyed, in the same manner as FIG. 16.

A plurality of the liquid discharge heads 306 may be disposed in an approximately parallel or perpendicular direction relative to a conveyance direction of the base material 211. Next, the base material 211 carrying discharged droplets of the liquid composition 12A is conveyed to a polymerization part 309 by the delivery roller 304 and the wind-up roller 305. In this manner, the adhesive porous resin 212 is formed to provide the applied material 210 having an adhesive porous resin on a base material. Then, the applied material 210 applied with an adhesive porous resin is cut into a desired size by die-cut or the like.

The polymerization part 309 may be disposed above or below the base material 211, or a plurality thereof may be disposed.

The polymerization part 309 is not particularly limited as long as it does not have direct contact with the liquid composition 12A. Example thereof include resistive heaters, infrared heaters, and fan heaters in thermal polymerization; and UV irradiators in photopolymerization. A plurality of the polymerization parts 309 may be disposed.

Conditions of heating or light irradiation are not particularly limited and can be appropriately selected corresponding to a purpose. Polymerization causes the liquid composition 12A to be polymerized to form an adhesive porous resin.

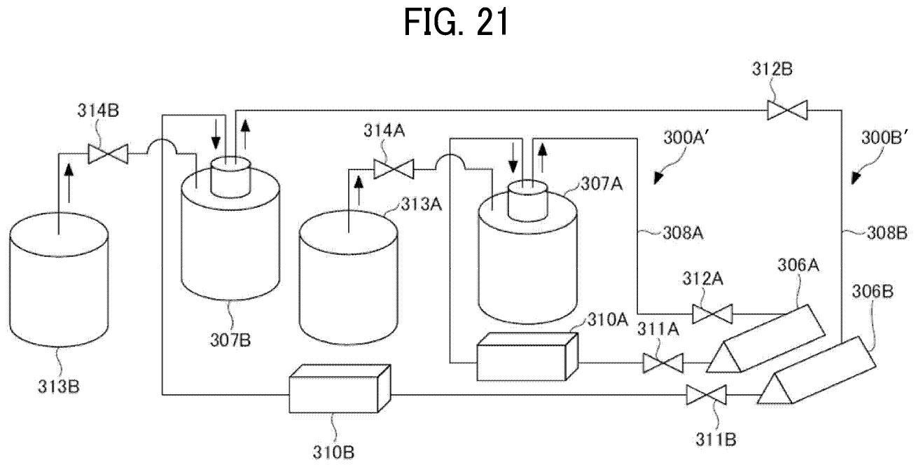

Additionally, as shown in FIG. 21, a tank 307A may supply a liquid composition from the tank 313A coupled to the tank 307A, and the liquid discharge head 306 may have a plurality of the liquid discharge heads 306A and 306B.

[Embodiment of Directly Applying Liquid Composition onto Base Material Thereby Forming Adhesive Porous Insulating Layer or Stack]

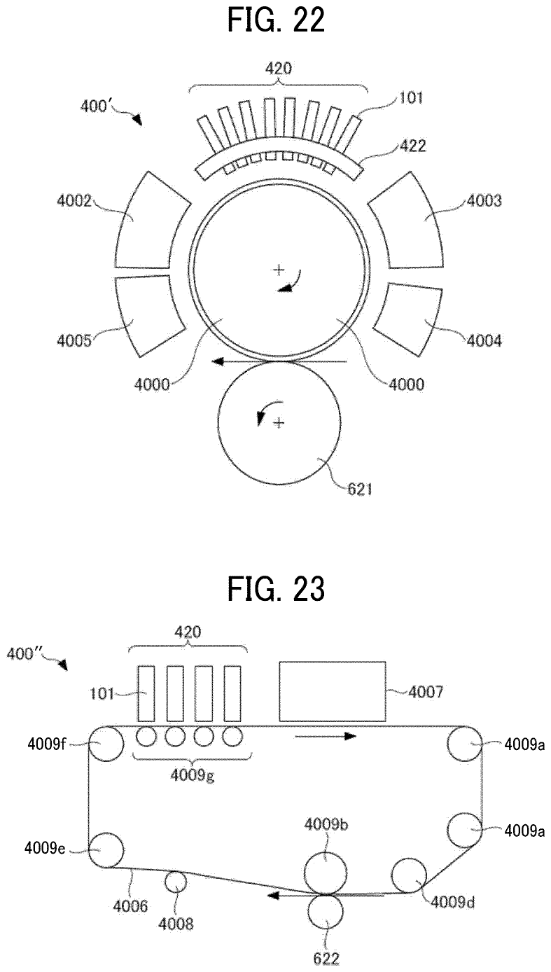

FIGS. 22 to 23 are configuration diagrams illustrating an exemplary printing part that employs an inkjet mode and a transfer mode as an application unit, as the production apparatus for an adhesive porous insulating layer according to the embodiment. FIG. 22 is a configuration diagram illustrating a printing part that employs a drum-shaped intermediate transfer body. FIG. 23 is a configuration diagram illustrating a printing part that employs an endless belt type intermediate transfer body.

A printing part 400′ shown in FIG. 22 is an inkjet printer that transfers a liquid composition or a porous resin on a base material via an intermediate transfer body 4001, thereby forming a porous resin on the base material.

The printing part 400′ includes an inkjet part 420, a transfer drum 4000, a pretreatment unit 4002, an absorption unit 4003, a heating unit 4004, and a cleaning unit 4005.

The inkjet part 420 includes a head module 422, which carries a plurality of heads 101. The head 101 discharges a liquid composition onto the intermediate transfer body 4001 supported on the transfer drum 4000 to form a liquid composition layer on the intermediate transfer body 4001. Each of the heads 101 is a line head in which nozzles are arranged over the width of a recording area of a base material having a maximal available size. The head 101 has a nozzle face including nozzles formed on the bottom face, and the nozzle face faces a surface of the intermediate transfer body 4001 via a minute gap. In the embodiment, the intermediate transfer body 4001 has a configuration to circulate and travel in a circular orbit, and a plurality of the heads 101 is thus arranged radially.

The transfer drum 4000 faces an impression cylinder 621 to form a transfer nip part. The pretreatment unit 4002 applies a reaction liquid for increasing viscosity of the liquid composition e.g., onto the intermediate transfer body 4001 before discharge of the liquid composition by the head 101. The absorption unit 4003 absorbs a liquid component from the liquid composition layer on the intermediate transfer body 4001 before transfer. The heating unit 4004 heats an ink layer on the intermediate transfer body 4001 before transfer. Heating of the liquid composition layer causes the liquid composition to be thermally polymerized to form a porous resin. Heating also removes a liquid, thereby improving transferability to a base material. The cleaning unit 4005 cleans an upper face of the intermediate transfer body 4001 after transfer, to remove foreign matter such as ink and dust remaining on the intermediate transfer body 4001.

The outer circumferential face of the impression cylinder 621 is pressed against the intermediate transfer body 4001, and the porous resin on the intermediate transfer body 4001 is transferred onto a base material when the base material passes through the transfer nip part between the impression cylinder 621 and the intermediate transfer body 4001. The impression cylinder 621 may be configured to include at least one grip mechanism to hold a tip of the base material on the outer circumferential face.

A printing part 400″ shown in FIG. 23 is an inkjet printer that transfers a liquid composition or a porous resin onto a base material via an intermediate transfer belt 4006, thereby forming a porous resin on the base material.

The printing part 400″ discharges droplets of a liquid composition from a plurality of heads 101 in the inkjet part 420, and forms a liquid composition layer on the outer circumference surface of the intermediate transfer belt 4006. The liquid composition layer formed on the intermediate transfer belt 4006 is heated with a heating unit 4007 and thermally polymerized, thereby forming a porous resin and turning it into a film on the intermediate transfer belt 4006.

In the transfer nip part where the intermediate transfer belt 4006 faces the transfer roller 622, the porous resin forming a film on the intermediate transfer belt 4006 is transferred onto the base material. The post-transfer surface of the intermediate transfer belt 4006 is cleaned with a cleaning roller 4008.

The intermediate transfer belt 4006 is bridged over a driving roller 4009a, a facing roller 4009b, a plurality of (four in the example) shape maintaining rollers 4009c, 4009d, 4009e, and 4009f, and a plurality of (four in the example) supporting rollers 4009g, and moves in a direction indicated by arrows in the figure. The supporting roller 4009g, which is disposed to face the heads 101, maintains a tension of the intermediate transfer belt 4006 during discharge of ink droplets from the heads 101.

### [Application of Porous Insulating Layer-Applied Material for Adhering Electrochemical Element Member, and Stack]

### <Application for Electrochemical Element>

Although applications of the porous insulating layer-applied material for adhering an electrochemical element member, and a stack are not particularly limited and can be appropriately selected corresponding to a purpose, the adhesive porous insulating layer is preferably an adhesive porous insulating layer for adhering an electrochemical element member.

In use for these applications, an insulating layer (separator) is preferably formed by, e.g., applying a liquid composition on an electrode composite layer formed on an electrode base as a base material.

When an electrode used in a power storage element such as a battery, a power-generating element such as a fuel cell, or another element is employed as a base material, less adhesion between an insulating layer of a porous structure and a base material can leads to deformation of a structure due to external impact, or may generate slippage between the porous structure and the base material and thus short circuit, upon penetration of any foreign matter such as a metallic piece.

The porous insulating layer-applied material for adhering an electrochemical element member and the stack according to the embodiment allows forming on a base material, an adhesive porous resin having adhesiveness, and excellent flexibility of an insulating layer and ion permeability, thereby enabling reduction of occurrence of stacking slippage of an electrode and thus reduction of generation of short circuit.

As an insulating layer for an electrochemical element, for example, a film porous insulating layer having a predetermined dimension of voids, porosity, etc. is known to be used. By contrast, use of the liquid composition allows appropriately changing voids and porosity by appropriately adjusting the content of a polymerizable compound, the content of a porogen, conditions of irradiation of active energy rays, etc., and provides improved flexibility in designing of performance of an electrochemical element. Moreover, the liquid composition can be developed in various application method, and thus can be applied by, e.g., an inkjet mode, thereby allowing improved flexibility in designing of the shape of an electrochemical element.

The insulating layer is a member that separates a positive electrode from a negative electrode, as well as retains ionic conductivity between the positive electrode and the negative electrode. Reference to insulating layer herein is not limited to have a layered shape.

The base material may be an insulating layer (film separator) for an electrochemical element, or may be a porous insulating layer rather than an adhesive porous insulating layer. Formation of the adhesive porous resin on the porous insulating layer allows addition of or improvement in various functions such as heat resistance, impact resistance, and high-temperature contraction resistance over the whole insulating layer.

### (Electrode)

The electrode according to an embodiment of the present invention includes the porous insulating layer-applied material for adhering an electrochemical element member according to an embodiment of the present invention as described above, wherein the base includes an electrode base and further includes the adhesive porous insulating layer as an outermost surface layer.

### (Production Method for Electrode and Production Apparatus for Electrode)

The method of producing an electrode according to an embodiment of the present invention includes an adhesive porous insulating layer formation step to form an adhesive porous insulating layer on a base material having an electrode base, and further includes another step as appropriate.

The production apparatus for an electrode according to an embodiment of the present invention includes an adhesive porous insulating layer formation unit to form an adhesive porous insulating layer on a base material having an electrode base, and further includes another unit as appropriate.

The adhesive porous insulating layer is a porous structure having an co-continuous structure including a resin as a backbone, wherein the resin is a cross-linked resin, and wherein the adhesive porous insulating layer has a peel strength of 2 N/m or more in a peel measuring method with use of a peel strength measuring element derived by preparing the base material as one of two base materials each having a size of 30 mm×100 mm, disposing the adhesive porous insulating layer through one entire face of each of the two base materials to provide adhesive porous insulating layers, placing the adhesive porous insulating layers to face each other, and performing thermal adhesion under conditions at a temperature of 140 °C and an air cylinder thrust of 500 N for 1 minute.

In regard to the adhesive porous insulating layer formation step and unit, the items described in the adhesive porous insulating layer formation step in the production method and the production apparatus of a stack according to an embodiment of the present invention can be appropriately selected except that the base material has an electrode base.

### <Electrode (First Electrode and Second Electrode)>

The electrode includes an electrode base and an adhesive porous insulating layer, and may further include at least either of an electrode composite layer or a porous insulating layer on the electrode base, as appropriate.

Negative electrodes and positive electrodes are collectively referred to as “electrode”. Electrode bases for a negative electrode and electrode bases for a positive electrode are collectively referred to as “electrode base”. Negative electrode composite layers and positive electrode composite layers are collectively referred to as “electrode composite layer”.

When a first electrode is a negative electrode, a second electrode refers to a positive electrode. When a first electrode is a positive electrode, a second electrode refers to a negative electrode. A positive electrode and a negative electrode may include an electrode composite layer, but can include no electrode composite layer when a reaction sufficiently generates inside a battery.

In addition, a porous insulating layer other than adhesive porous insulating layers may be included for the purpose of ensuring a battery property and preventing short circuit, etc.

### <Electrode Base>

The electrode base is not particularly limited as long as it is a conductive base material. Examples thereof include, but are not limited to, aluminum foil, copper foil, stainless steel foil, titanium foil, etched foil having fine holes made by etching the above foil, and perforated electrode bases used for lithium ion capacitors. Such an electrode base can be preferably used for secondary batteries and capacitors, which are typical power storage elements, and particularly preferably used for lithium ion secondary batteries.

Further, carbon paper used for power generation devices (e.g., fuel cells), a fibrous electrode in a non-woven or woven planar form, and the above-described perforated electrode base having fine holes may also be used. Moreover, for solar devices, a flat base material made of glass or plastic may also be used on which a transparent semiconductor film of indium-titanium oxide or zinc oxide is formed or a thin conductive electrode film is deposited, in addition to the above-described electrode.

### <Electrode Composite Layer>

The electrode composite layer (hereinafter referred to as “active material layer”) is not particularly limited and can be appropriately selected corresponding to a purpose. For example, the electrode composite layer may contain an active material (a negative electrode active material or a positive electrode active material) and optionally a binder, a thickener, a conducting agent, or the like.

A negative electrode composite layer and a positive electrode composite layer are each formed by dispersing a powdery active material, a binder, a conductive material, etc. in a liquid, then applying and fixing the liquid onto an electrode base, followed by drying. The applying is performed using a spray, a dispenser, a die coater, a pull-up coating, or the like. The electrode composite layer is each formed by dispersing a powdery active material, a catalyst composition, etc. in a liquid, then applying and fixing the liquid onto an electrode base, followed by drying. The formation is typically performed by printing using a spray, a dispenser, a die coater, a pull-up coating or the like, followed by post-application drying.

### «Active Material»

The positive electrode active material is not particularly limited as long as it is a material that can reversibly occlude and release alkali metal ions. Typically, an alkali-metal-containing transition metal compound may be used as the positive electrode active material. Examples of a lithium-containing transition metal compound include, but are not limited to, composite oxide containing lithium and at least one element selected from the group consisting of cobalt, manganese, nickel, chromium, iron, and vanadium. Examples of the composite oxide include, but are not limited to, lithium-containing transition metal oxides such as lithium cobalt oxide, lithium nickel oxide, and lithium manganese oxide; olivine-type lithium salts such as LiFePO₄; chalcogen compounds such as titanium disulfide and molybdenum disulfide; and manganese dioxide. The lithium-containing transition metal oxide refers to a metal oxide containing lithium and a transition metal, or a metal oxide having substitution of a part of the transition metal in the aforementioned metal oxide with a different element.

Examples of the different element include, but are not limited to, Na, Mg, Sc, Y, Mn, Fe, Co, Ni, Cu, Zn, Al, Cr, Pb, Sb, and B. In particular, Mn, Al, Co, Ni, and Mg are preferred. The different element may be employed as a single species or two or more species. A positive electrode active material thereof can be used alone or in combination with others. Examples of the active material in a nickel metal hydride battery include, but are not limited to, nickel hydroxide.

The negative electrode active material is not particularly limited as long as it is a material that can reversibly occlude and release alkali metal ions. Typically, a carbon material including graphite having a graphite-type crystal structure may be used as the negative electrode active material. Examples of such a carbon material include, but are not limited to, natural graphite, spherical or fibrous synthetic graphite, poorly-graphitizable carbon (hard carbon), and easily-graphitizable carbon (soft carbon). A material other than carbon materials may be lithium titanate. Additionally, in view of improving energy density of a lithium ion battery, a high capacitance materials such as silicon, tin, silicon alloy, tin alloy, silicon oxide, silicon nitride, or tin oxide can also be preferably used as the negative electrode active material.

Examples of the aforementioned active material in nickel metal hydride batteries include, but are not limited to, AB2-type and A2B-type hydrogen storage alloys.

### «Binder»

Examples of an available binder of the positive electrode or negative electrode include, but are not limited to: PVDF, PTFE, polyethylene, polypropylene, aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulfone, hexafluoropolypropylene, styrene butadiene rubber, and carboxymethyl cellulose. Copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid and hexadiene may also be used. A mixture of two or more materials selected from these materials may also be used. Examples of a conducting agent contained in the electrode include, but are not limited to: graphites such as natural graphite and synthetic graphite; carbon blacks such as acetylene black, Ketjen black, channel black, furnace black, lamp black, and thermal black; conductive fibers such as carbon fibers and metal fibers; carbon fluoride; powders of metals such as aluminum; conductive whiskers such as zinc oxide and potassium titanate; conductive metal oxides such as titanium oxide; and organic conductive materials such as phenylene derivatives and graphene derivatives.

In general, an active material in a fuel cell serves as a catalyst for a cathode electrode or an anode electrode and employs catalyst particles (e.g., fine particles of a metal such as platinum, ruthenium, and platinum alloy) supported on a catalyst carrier (e.g., carbon). The catalyst particles can be made supported on a surface of the catalyst carrier by suspending the catalyst carrier in water, then adding precursors of the catalyst particles thereto to make them dissolved in the suspension, and further adding an alkali to produce a hydroxide of the metal. Here, specific examples of the precursors of the catalyst particles include, but are not limited to, chloroplatinic acid, dinitrodiamino platinum, platinum(IV) chloride, platinum(II) chloride, bisacetylacetonatoplatinum, dichlorodiammine platinum, dichlorotetramine platinum, platinum sulfate chlororuthenate, hexachloroiridate, hexachlororhodate, ferric chloride, cobalt chloride, chromium chloride, gold chloride, silver nitrate, rhodium nitrate, palladium chloride, nickel nitrate, iron sulfate, and copper chloride. The catalyst carrier is then applied onto an electrode and reduced under a hydrogen atmosphere or the like, thus preparing an electrode having a surface coated with the catalyst particles (active material).

In solar cells, the active material may be tungsten oxide powder, titanium oxide powder, or a semiconductor layer of an oxide (e.g., SnO₂, ZnO, ZrO₂, Nb₂O₅, CeO₂, SiO₂, and Al₂O₃) carrying a dye (e.g., ruthenium-tris transition metal complex, ruthenium-bis transition metal complex, osmium-tris transition metal complex, osmium-bis transition metal complex, ruthenium-cis-diaqua-bipyridyl complex, phthalocyanine and porphyrin, and organic-inorganic perovskite crystal).

### «Conducting Agent»

Examples of the conducting agent to be used include, but are not limited to: graphites such as natural graphite and synthetic graphite; carbon blacks such as acetylene black, Ketjen black, channel black, furnace black, lamp black, and thermal black; conductive fibers such as carbon fibers and metal fibers; carbon fluoride; powders of metals such as aluminum; conductive whiskers such as zinc oxide and potassium titanate; conductive metal oxides such as titanium oxide; and organic conductive materials such as phenylene derivatives and graphene derivatives.

### (Electrochemical Element)

An electrochemical element according to the first embodiment of the present invention includes a first electrode, and a second electrode insulated from the first electrode, wherein the first electrode and the second electrode form together a stack, and wherein at least either of the first electrode or the second electrode is the electrode according to an embodiment of the present invention as described above.

An electrochemical element according to the second embodiment of the present invention has the stack according to an embodiment of the present invention as described above, wherein the first base material has an electrode base, and wherein the second base material has an electrode base.

An electrochemical element to which the embodiment is applicable is not particularly limited. Typical examples thereof include, but are not limited to, a secondary battery and a capacitor, which are storage elements, and particularly preferred examples include, but are not limited to, a lithium-ion secondary battery.

Additionally, in an electrochemical element member according to the embodiment, it is preferred that the first electrode be disposed outside the second electrode and adhered to the second electrode via the adhesive porous insulating layer.

For example, the electrochemical element member includes a structure including a negative electrode outside a positive electrode, wherein the negative electrode and the positive electrode are stacked with inserting an insulating layer, adhered via the adhesive porous insulating layer, and insulated from each other via the insulating layer. A battery is formed of the electrochemical element member, an electrolyte injected in the electrochemical element member, and an outer package to seal the electrochemical element member and the electrolyte.

### <Electrolyte>

The electrolyte may be formed of an electrolytic solution or a solid electrolyte. When an electrolyte layer is an electrolytic solution, it is preferably a non-aqueous electrolytic solution formed by dissolving an electrolytic salt in a non-aqueous solvent.

### —Non-Aqueous Solvent—

The non-aqueous solvent is preferably an aprotic organic solvent.

Examples of the aprotic organic solvent include, but are not limited to, carbonate-based organic solvents, ester-based organic solvents, and ether-based organic solvents, and low-viscosity solvents are preferred.

Examples of the carbonate-based organic solvents include, but are not limited to, linear carbonates and cyclic carbonates. Each of these may be used alone or in combination with others.

In particular, linear carbonates are preferred because of their high capability of dissolving an electrolyte salt.

Examples of the linear carbonates include, but are not limited to, dimethyl carbonate (DMC), diethyl carbonate (DEC), and methyl ethyl carbonate (EMC). Each of these may be used alone or in combination with others. In particular, dimethyl carbonate (DMC) and methyl ethyl carbonate (EMC) are preferable.

In use of a mixed solvent derived by combining dimethyl carbonate (DMC) and methyl ethyl carbonate (EMC), the mixing ratio of dimethyl carbonate (DMC) and methyl ethyl carbonate (EMC) is not particularly limited and can be appropriately selected corresponding to a purpose.

Examples of the cyclic carbonates include, but are not limited to, propylene carbonate (PC), ethylene carbonate (EC), butylene carbonate (BC), vinylene carbonate (VC), and fluoroethylene carbonate (FEC). Each of these may be used alone or in combination with others. In particular, propylene carbonate (PC) and ethylene carbonate (EC) are preferable. In use of a mixed solvent derived by combining ethylene carbonate (EC) as the cyclic carbonate and dimethyl carbonate (DMC) as the linear carbonate, the mixing ratio of ethylene carbonate (EC) and dimethyl carbonate (DMC) is not particularly limited and can be appropriately selected corresponding to a purpose.

Examples of the ester-based organic solvents include, but are not limited to, cyclic esters and linear esters.

Examples of the cyclic esters include, but are not limited to, γ-butyrolactone (γ-BL), 2-methyl-γ-butyrolactone, acetyl-γ-butyrolactone, and γ-valerolactone.

Examples of the linear esters include, but are not limited to, propionic acid alkyl esters, malonic acid dialkyl esters, acetic acid alkyl esters, and formic acid alkyl esters.

Examples of the acetic acid alkyl esters include, but are not limited to, methyl acetate (MA) and ethyl acetate.

Examples of the formic acid alkyl esters include, but are not limited to, methyl formate (MF) and ethyl formate.

Examples of the ether-based organic solvents include, but are not limited to, cyclic ethers and linear ethers.

Examples of the cyclic ethers include, but are not limited to, tetrahydrofuran, alkyltetrahydrofuran, alkoxytetrahydrofuran, dialkoxytetrahydrofuran, 1,3-dioxolan, alkyl-1,3-dioxolan, and 1,4-dioxolan.

Examples of the linear ether include, but are not limited to, 1,2-dimethoxyethane (DME), ethylene glycol dialkyl ethers, diethylene glycol dialkyl ethers, triethylene glycol dialkyl ethers, and tetraethylene glycol dialkyl ethers.

### —Electrolyte Salt—

An electrolyte salt to be used for the non-aqueous electrolytic solution is preferably a lithium salt.

The lithium salt is not particularly limited and can be appropriately selected corresponding to a purpose, as long as it can be dissolved in a non-aqueous solvent and exhibits high ionic conductivity. Examples thereof include, but are not limited to, lithium hexafluorophosphate (LiPF₆), lithium perchlorate (LiClO₄), lithium chloride (LiCl), lithium tetrafluoroborate (LiBF₄), lithium hexafluoroarsenate (LiAsF₆), lithium trifluoromethasulfonate (LiCF₃SO₃), lithium bistrifluoromethanesulfonylimide (LiN(SO₂CF₃)₂), lithium bisperfluoroethylsulfonylimide (LiN(SO₂C₂F₅)₂), and lithium bisfluorosulfonylimide (LiN(SO₂F)₂). Each of these may be used alone or in combination with others. In particular, LiPF₆, LiBF₄, and LiN(SO₂F)₂ are preferable in view of large occlusion amount of anions into an electrode.

The concentration of the electrolyte salt is not particularly limited and can be appropriately selected corresponding to a purpose. In view of combining discharge capacity and output, the concentration is preferably 1.0 mol/L or more to 6 mol/L or less, and more preferably 1.5 mol/L or more to 4 mol/L or less.

### —Solid Electrolyte—

Examples of solid electrolyte particles available as the solid electrolyte include, but are not limited to, sulfide-based amorphous solid electrolyte particles, oxide-based amorphous solid electrolyte particles, and crystalline oxides.

### (Production Method for Electrochemical Element and Production Apparatus for Electrochemical Element)

The method of producing an electrochemical element according to an embodiment of the present invention includes an electrode production step to produce an electrode by the method of producing an electrode according to an embodiment of the present invention as described above, and an element formation step to use the electrode to produce an electrochemical element, and further includes another step as appropriate.

The production apparatus for an electrochemical element according to an embodiment of the present invention includes an electrode production part to produce an electrode by the method of producing an electrode according to an embodiment of the present invention as described above, and an element formation part to use the electrode to produce an electrochemical element, and further includes another unit as appropriate.

### <Electrode Production Step and Electrode Production Part>

The electrode production step can appropriately select the items described in the method of producing an electrode according to an embodiment of the present invention as described, includes an adhesive porous insulating layer formation step, and further includes another step such as an electrode processing step as appropriate.

The electrode production part can appropriately select the items described in the production apparatus for an electrode according to an embodiment of the present invention as described, includes an adhesive porous insulating layer formation unit, and further includes another unit such as an electrode processing unit as appropriate.

The electrode production step and the electrode production part enables production of an electrode including an electrode base and an adhesive porous insulating layer on the electrode base. The electrode may be a stack electrode including an electrolyte layer, or an electrolyte layer-integrated stack electrode where an electrode composite layer on an electrode base is integrated with the porous resin.

In regard to the applying treatment and the applying part, the items described in the production method and the production apparatus of a stack can be appropriately selected. In regard to the polymerization treatment and the polymerization part, the items described in the production apparatus and the production method for a stack can be appropriately selected.

### <Element Formation Step and Element Formation Part>

The element formation step is a step of using the stack battery to produce an electrochemical element.

The element formation part is a unit to use the stack battery to produce an electrochemical element.

A method of producing an electrochemical element using a battery is not particularly limited, and a known method of producing an electrochemical element can be appropriately selected. Examples thereof include, but are not limited to, a method of causing facing electrodes to be at least any of placed, rolled or stacked, or stored in a container, and thereby providing a power storage element.

The element formation step need not include all steps of element formation, and may include a part of steps of element formation.

### <Electrode Processing Step and Electrode Processing Part>

An electrode processing part processes a stack electrode including a resin layer formed therein, downstream from the applying part.

The electrode processing part may perform at least one of cutting, folding, or pasting together. A stack electrode processing part can, e.g., cut a stack electrode including a resin layer formed therein and produce a stack including the stack electrode. The electrode processing part can roll or stack a stack electrode having a resin layer formed thereon.

The electrode processing part has, e.g., an electrode processing device to perform cutting, zigzag folding, stacking, and rolling of a stack electrode having a porous resin layer formed thereon, corresponding to an intended battery form.

The electrode processing step, which is performed by the electrode processing part, is a step of processing a stack electrode including a resin layer formed therein, e.g., downstream from an applying step. The electrode processing step may include at least one of a cutting step, a folding step, or a pasting step.

### EXAMPLES

Description will now be made for the present invention with reference to the examples in more detail, but the present invention is not limited to the following examples.

### <Preparation of Liquid Composition for Forming Resin>

Liquid compositions 1 to 4 for forming resins 1 to 4 were prepared by mixing raw materials in proportions as follows.

### —Preparation of Liquid Composition 1 for Forming Resin 1—

Liquid composition 1 for forming resin 1, which is another porous resin, was produced by mixing components with the following proportions: 29.0% by mass of tricyclodecane dimethanol diacrylate (EBECRYL 130, manufactured by Daicel-Allnex Ltd.) as a polymerizable compound, 70.0% by mass of dipropylene glycol monomethyl ether (manufactured by Kanto Chemical Co., Ltd.) as a porogen, and 1.0% by mass of IRGACURE 184 (manufactured by BASF SE) as a polymerization initiator.

### —Preparation of Liquid Composition 2 for Forming Resin 2—

Liquid composition 2 for forming resin 2, which is an adhesive porous resin, was produced by mixing components with the following proportions: 29.0% by mass of KAYARAD PEG400DA (manufactured by Nippon Kayaku Co., Ltd.) as a polymerizable compound, 70.0% by mass of methyl decanoate (manufactured by Kanto Chemical Co., Ltd.) as a porogen, 1.0% by mass of IRGACURE 819 (manufactured by BASF SE) as a polymerization initiator.

### —Preparation of Liquid Composition 3 for Forming Resin 3—

Liquid composition 3 for forming resin 3, which is a comparative thermoplastic resin, was produced by mixing components with the following proportions: 29.0% by mass of W #9100 (manufactured by Kureha Corporation) as a thermoplastic resin, 70.0% by mass of NMP (manufactured by Mitsubishi Chemical Corporation) as a solvent, and 1.0% by mass of IRGACURE 819 (manufactured by BASF SE) as a polymerization initiator.

### —Preparation of Liquid Composition 4 for Forming Resin 4—

Liquid composition 4 for forming resin 4, which is an adhesive porous resin, was produced by mixing components with the following proportions: 29.0% by mass of SR502 NS (ethoxylated (9) trimethylolpropane triacrylate, manufactured by Sartomer USA, LLC (present Arkema S.A.)) as a polymerizable compound, 70.0% by mass of methyl decanoate (manufactured by Kanto Chemical Co., Ltd.) as a porogen, and 1.0% by mass of IRGACURE 819 (manufactured by BASF SE) as a polymerization initiator.

### <Preparation of Liquid Composition for Forming Inorganic Solid Layer>

A liquid composition for forming an inorganic solid layer was prepared by mixing raw materials with the following proportions to provide a pre-liquid dispersion and dispersing the pre-liquid dispersion by the following procedure.

### —Liquid Composition for Forming Inorganic Solid Layer—

A pre-liquid dispersion was prepared by mixing components with the following ratios: 40.0% by mass of α-alumina (primary particle diameter (D50): 0.5 μm, specific surface area: 7.8 g/m²) as an inorganic solid, 58.0% by mass of a mixture solution of dimethylsulfoxide and ethylene glycol (DMSO-EG, mass ratio: 3:4), and 2.0% by mass of MALIALIM HKM-150A (manufactured by NOF Corporation) as a dispersant. The pre-liquid dispersion was put together with zirconia beads (Φ2 mm) into a container, subject to dispersion at 1,500 rpm for 3 minutes in a refrigeration nano grinder NP-100 (manufactured by Thinky Corporation) to provide a liquid dispersion. From the liquid dispersion thus obtained, zirconia beads were removed with a 25 μm mesh filter to prepare a liquid composition for formation of an inorganic solid layer.

### <Preparation of Negative Electrode>

### —Preparation of Negative Electrode Paint—

A negative electrode paint was prepared by adding 97.0% by mass of graphite, 1.0% by mass of a thickener (carboxymethyl cellulose), and 2.0% by mass of a macromolecule (styrene butadiene rubber), all of which are components for forming a negative electrode composite layer, and 100.0% by mass of water as a solvent.

### —Preparation of Negative Electrode—

As shown in FIG. 9, the negative electrode paint was applied onto both sides of a copper foil base (areas of the first electrode composite layers 9), followed by drying to form negative electrode composite layers with a weight per area of 9.0 mg/cm² on one side. Then, pressing was performed in a roll press machine so as to provide an electrode with a deposition density of 1.6 g/cm³, to produce a negative electrode. At that time, the average thickness of the negative electrode was 112.0 μm.

### <Preparation of Positive Electrode>

### —Preparation of Positive Electrode Paint—

A positive electrode paint was prepared by providing 92.0% by mass of lithium nickel oxide (NCA) as a positive electrode active material, 3.0% by mass of acetylene black as a conductive material, and 5.0% by mass of polyvinylidene fluoride (PVDF) as a binder, and dispersing them in N-methylpyrrolidone (NMP).

### —Preparation of Positive Electrode—

The positive electrode paint was applied onto both sides of an aluminum foil base, followed by drying to provide positive electrode composite layers having a weight per area of 15.0 mg/cm² on one side. Then, pressing was performed in a roll press machine so as to provide an electrode with a volume density of 2.8 g/cm³, to produce a positive electrode. At that time, the average thickness of the positive electrode was 132.0 μm.

### Example 1

### <Production of Negative Electrode Stack>

As shown in FIG. 1 and FIG. 2, liquid composition 1 for resin 1 was filled in an inkjet discharge apparatus equipped with a GEN5 head (manufactured by Ricoh Printing Systems Co., Ltd. (present Ricoh Industry Co., Ltd.)). With controlling the amount of liquid composition 1 discharged onto a negative electrode composite layer in a negative electrode, an applied region was formed so as to provide the porous insulating layer 10a with an average thickness of 20.0 μm.

Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. Next, the cured material was heated at 130 °C for 1 minute with a hot plate to remove a porogen, thereby providing the porous insulating layer 10a.

Subsequently, liquid composition 2 for resin 2 was filled in an inkjet discharge apparatus equipped with a GEN5 head. Then, as shown in FIG. 1 and FIG. 2, liquid composition 2 was discharged onto an area indicated by the adhesive porous insulating layer 10b to form an applied region with an average thickness of 100.0 μm. Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. After the curing, the cured material was heated at 130 °C for 1 minute with a hot plate to remove a porogen, thereby providing the adhesive porous insulating layer 10b.

In this manner, as shown in FIG. 1 and FIG. 2, the negative electrode stack in Example 1 was produced as a first electrode where the porous insulating layer 10a was formed of resin 1 on the first electrode composite layer 9, and where the adhesive porous insulating layer 10b was formed of resin 2 at three sides around the porous insulating layer 10a on the first electrode composite layer 9.

### <Preparation of Electrochemical Element>

As shown in FIG. 3, the negative electrode including the porous insulating layer 10a and the adhesive porous insulating layer 10b formed therein as a first electrode, and a positive electrode as a second electrode were faced to each other and stacked together, and the adhesive porous insulating layer 10b was thermally adhered at a temperature of 140 °C and an air cylinder thrust of 500 N for 1 second. Then, vacuum drying was performed at 150 °C for removing remaining water.

Then, an electrolytic solution was injected, followed by sealing with laminate outer package material as an outer package, to prepare the electrochemical element (power storage element) in Example 1.

The electrolytic solution used above was a solution derived by adding LiPF₆, an electrolyte, in a mixture of ethylene carbonate (EC) and dimethyl carbonate (DMC) (a mixture with EC:DMC=1:1 (mass ratio)) so as to provide a concentration of 1.5 mol/L.

### <Evaluation>

Peel strength, flexibility, and ion permeability of an adhesive porous insulating layer were evaluated as the following procedure.

### «Measurement of Peel Strength of Insulating Layer»

### —Preparation of Peel Strength Measuring Element—

Liquid composition 1 was applied and cured thorough one entire face of two electrodes each having a size of 30 mm×100 mm, thereby preparing two electrodes each having the adhesive porous insulating layer 10b formed thereon. The two electrodes were set as test electrodes a and b. Then, the parts applied with the adhesive porous insulating layer 10b in the two electrodes were placed to face each other, and thermally adhered under conditions at a temperature of 140 °C and an air cylinder thrust of 500 N for 1 minute, thereby preparing a “peel strength measuring element”.

As the thickness of the adhesive porous insulating layer 10b, the thickness described in each of Examples and Comparative Examples evaluation was subjected to evaluation.

### —Measurement of Peel Strength—

A side facing a side forming an adhesive porous insulating layer in an electrode base of test electrode a of a peel strength measuring element, and a sample fixing face in a peel strength measuring device were fixed together with a thin double-sided tape. Then, a side facing a side forming an adhesive porous insulating layer in an electrode base of test electrode b of the peel strength measuring element, and a tensile indenter of the peel strength measuring device were fixed together with a tape. Peel strength was measured under the following measuring conditions.

### —Measuring Conditions of Peel Strength—

Peel strength measuring device: adherent
Coating peeling analyzer Versatile Peel Analyzer (manufactured by Kyowa Interface Science Co., Ltd.)
Thin double-sided tape: No. 5000NS (20 mm in width, manufactured by Nitto Denko Corporation)
Tape: No. 29 (18 mm in width, manufactured by Nitto Denko Corporation)
Measuring speed: 30 mm/min
Peeling angle: 90°
Peeling distance: 75 mm

### «Flexibility Evaluation of Insulating Layer»

An electrode was prepared in the same manner as test electrode a in measurement of peel strength of an insulating layer, cut into a 100 mm square, and subjected to a bending test using a cylindrical mandrel bending tester equipped with a cylindrical mandrel having a diameter of 4 mm (manufactured by Kotec Ltd.). Then, observation was made for presence or absence of a crack in the insulating layer before and after the bending test.

### —Measuring Conditions of Flexibility—

Test device name: cylindrical mandrel bending tester stand (manufactured by Kotec Ltd. or Allgood Co., Ltd.)
Requisite jig: mandrel rod with a diameter of 4 mm (id.)

Presence or absence of a crack in the insulating layer was evaluated visually and with use of an optical microscope. Less cracks in the insulating layer is accompanied by better bendability.

### [Evaluation Criteria]

Yes: no crack in the insulating layer.
No: presence of crack in the insulating layer.

### «Ion Permeability Evaluation of Insulating Layer»

Evaluation of ion permeability of the insulating layer was performed by image observation with a scanning electron microscope (SEM) and measurement of porosity.

The adhesive porous insulating layer 10b was clipped to 5 mm×10 mm in size, and subjected to osmium staining with osmium (VIII) oxide (manufactured by Nisshin-EM Co., Ltd.). In particular, the adhesive porous insulating layer thus clipped was put into a bottle containing a small amount of an aqueous solution thereof so as not to contact the aqueous solution, and left to stand in a sealed bottle for 30 minutes to be stained. Then, the layer is dried in a draft for 1 hour to provide a sample.

After sufficient drying, the sample was vacuum-impregnated with a two-component epoxy resin (manufactured by ITW Performance Polymers & Fluids Japan Co., Ltd.). Then, a cross section was cut at 5.0 kV with a cross section polisher (manufactured by JEOL Ltd.), and observed with a cryoFIB/SEM (manufactured by FEI Company Japan Ltd.).

The porosity of the adhesive porous insulating layer 11b was calculated by binarizing the observed image and deriving a proportion of pores in an observation area. On the basis of the calculated porosity, ion permeability was evaluation.

### [Evaluation Criteria]

Yes: having a porosity of less than 30%
No: having a porosity of 30% or more

### Example 2

As shown in FIG. 1 and FIG. 4, the liquid composition for resin 1 was filled in an inkjet discharge apparatus equipped with a GEN5 head (manufactured by Ricoh Printing Systems Co., Ltd. (present Ricoh Industry Co., Ltd.)). With controlling the amount of the liquid composition discharged onto a negative electrode composite layer in a negative electrode, an applied region was formed so as to provide the porous insulating layer 11a with a film thickness of 20.0 μm.

Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. Next, the cured material was heated at 130 °C for 1 minute with a hot plate to remove a porogen, thereby providing the porous insulating layer 10a.

Subsequently, the liquid composition for resin 2 was filled in an inkjet discharge apparatus equipped with a GEN5 head. The liquid composition was discharge onto the porous insulating layer 11a on the negative electrode having 20.0 μm of resin 1 formed therein to form an applied region having a film thickness of 65.0 μm in an area indicated by the adhesive porous insulating layer 10b as shown in FIG. 1 and FIG. 4. Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. After the curing, the cured material was heated at 130 °C for 1 minute with a hot plate to remove a porogen, thereby providing the adhesive porous insulating layer 10b.

In this manner, as shown in FIG. 4, the negative electrode stack in Example 2 was produced by stacking the first electrode base 8, the first electrode composite layer 9, the porous insulating layer 10a, and the adhesive porous insulating layer 10b in this order. An evaluation was performed as in Example 1. The results are shown in Table 1.

The electrochemical element in Example 2 was produced in the same manner as in Example 1 except for using a negative electrode stack in Example 2 instead of that in Example 1.

### Example 3

As shown in FIG. 7 and FIG. 8, a liquid composition for resin 2 was filled in an inkjet discharge apparatus equipped with a GEN5 head. The liquid composition was discharged onto a negative electrode active material in an area not including a film separator of a negative electrode, thereby forming an applied region having a pattern image and a film thickness of 90.0 μm in an area indicated by the adhesive porous insulating layer 10b. Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. After the curing, the cured material was heated at 130 °C for 1 minute with a hot plate to remove a porogen, thereby providing the adhesive porous insulating layer 10b.

Subsequently, a separator formed of a polypropylene microporous membrane on the negative electrode active material (SETELA (F20BHE), manufactured by Toray Industries, Inc. and having a thickness of 20 μm) was disposed in an area indicated by the adhesive porous insulating layer 10b shown in FIG. 8 and FIG. 10.

### Example 4

As shown in FIG. 1 and FIG. 2, the liquid composition for resin 1 is filled in an inkjet discharge apparatus equipped with a GEN5 head (manufactured by Ricoh Printing Systems Co., Ltd. (present Ricoh Industry Co., Ltd.)). With controlling the amount of the liquid composition discharged onto a negative electrode composite layer in a negative electrode, an applied region was formed so as to provide the porous insulating layer 10a with a film thickness of 20.0 μm.

Immediately then, under N₂ atmosphere, the applied region was irradiated with UV (light source: UV-LED (Manufactured by Phoseon Technology Ltd., product name: FJ800), wavelength: 362 nm, irradiation strength: 30 mW/cm², irradiation time: 20 seconds) and cured. Next, the cured material was heated at 130 °C for 1 minute with a hot plate to remove a porogen, thereby providing the porous insulating layer 10a.

Subsequently, the liquid composition for resin 4 was filled in an inkjet discharge apparatus equipped with a GEN5 head. The liquid composition was discharged onto the porous insulating layer 10a having 20.0 μm of resin 1 formed on a negative electrode, to form an applied region having a film thickness of 65.0 μm in an area indicated by the adhesive porous insulating layer 10b as shown in FIG. 1 and FIG. 4. Immediately then, under N₂ atmosphere, the applied region was irradiated with UV (light source: UV-LED (Manufactured by Phoseon Technology Ltd., product name: FJ800), wavelength: 362 nm, irradiation strength: 30 mW/cm², irradiation time: 20 seconds) and cured. After the curing, the cured material was heated at 130 °C for 1 minute with a hot plate to remove a porogen, thereby providing the adhesive porous insulating layer 10b.

In this manner, as shown in FIG. 3, the negative electrode stack in Example 4 was produced by stacking the first electrode base 8, the first electrode composite layer 9, the porous insulating layer 10a, and the adhesive porous insulating layer 10b in this order. An evaluation was performed as in Example 1. The results are shown in Table 1.

The electrochemical element in Example 4 was produced in the same manner as in Example 1 except for using a negative electrode stack in Example 4 instead of that in Example 1.

### Comparative Example 1

As shown in FIG. 1 and FIG. 2, the liquid composition for resin 1 is filled in an inkjet discharge apparatus equipped with a GEN5 head (manufactured by Ricoh Printing Systems Co., Ltd. (present Ricoh Industry Co., Ltd.)). With controlling the amount of the liquid composition discharged onto a negative electrode active material in a negative electrode, an applied region was formed so as to provide the porous insulating layer 10a with a film thickness of 20.0 μm.

Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. Next, the cured material was heated at 130 °C for 1 minute with a hot plate to remove a porogen, thereby providing the porous insulating layer 10a.

Subsequently, a liquid composition for resin 3 was filled in an inkjet discharge apparatus equipped with a GEN5 head. The liquid composition was discharged onto a negative electrode active material of a negative electrode, thereby forming an applied region having a pattern image and a film thickness of 85.0 μm in an area indicated by the adhesive porous insulating layer 10b as shown in FIG. 1 and FIG. 2. Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. After the curing, the cured material was heated at 130 °C for 1 minute with a hot plate to remove a solvent, thereby providing the adhesive porous insulating layer 10b formed of resin 3 (thermoplastic resin).

Note that this adhesive porous insulating layer 10b is formed of a thermoplastic resin, and thus lacks porosity by heating for removing a solvent.

### Comparative Example 2

As shown in FIG. 1 and FIG. 2, a liquid composition for resin 1 was filled in an inkjet discharge apparatus equipped with a GEN5 head (manufactured by Ricoh Printing Systems Co., Ltd. (present Ricoh Industry Co., Ltd.)). With controlling the amount of the liquid composition discharged onto a negative electrode active material in a negative electrode, an applied region was formed so as to provide the porous insulating layer 11a with a film thickness of 20.0 μm.

Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. Next, the cured material was heated at 130 °C for 1 minute with a hot plate to remove a porogen, thereby providing the porous insulating layer 10a.

Subsequently, a liquid composition for an inorganic solid was filled in an inkjet discharge apparatus equipped with a GEN5 head. The liquid composition was discharged onto a negative electrode active material in a negative electrode to form an applied region having a film thickness of 85.0 μm in an area indicated by the adhesive porous insulating layer 10b and a pattern image as shown in FIG. 1 and FIG. 2. Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. Next, the cured material was heated at 130 °C for 1 minute with a hot plate to remove a porogen, thereby providing the adhesive porous insulating layer 10b formed of an inorganic solid.

### Comparative Example 3

As shown in FIG. 1 and FIG. 2, a liquid composition for resin 1 was filled in an inkjet discharge apparatus equipped with a GEN5 head (manufactured by Ricoh Printing Systems Co., Ltd. (present Ricoh Industry Co., Ltd.)). With controlling the amount of the liquid composition discharged onto a negative electrode active material in a negative electrode, an applied region was formed so as to provide the porous insulating layer 11a with a film thickness of 20.0 μm.

Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. Next, the cured material was heated at 130 °C for 1 minute with a hot plate to remove a porogen, thereby providing the porous insulating layer 10a.

Subsequently, the liquid composition for resin 1 was discharged onto a negative electrode active material of a negative electrode, thereby forming an applied region having a pattern image and a film thickness of 85.0 μm in an area indicated by the adhesive porous insulating layer 10b as shown in FIG. 1 and FIG. 2. Immediately then, under N₂ atmosphere, the applied region was irradiated with UV (light source: UV-LED (manufactured by Phoseon Technology Ltd., product name: FJ800), wavelength: 365 nm, irradiation strength: 30 mW/cm², irradiation time: 20 seconds) and cured. After the curing, the cured material was heated at 130 °C for 1 minute with a hot plate to remove a porogen, thereby providing the adhesive porous insulating layer 10b formed of resin 1. The glass transition point (Tg) of resin 1 was 190 °C.

TABLE 1

| | | | | | Electro- | | | |
|---|---|---|---|---|---|---|---|---|
| | Negative electrode stack | | | | chemical | | | |
| | | | | Adhesive | element | Evaluation | | |
| | | Cross- | Porous | porous | Cross- | Peel | | |
| | Plan | sectional | insulating | insulating | sectional | strength | | Ion |
| | view | view | layer 10a | layer 10b | view | [N/m] | Flexibility | permeability |
| Example 1 | FIG. 1 | FIG. 2 | Resin 1 | Resin 2 | FIG. 3 | 25 | Yes | Yes |
| Example 2 | FIG. 1 | FIG. 4 | Resin 1 | Resin 2 | FIG. 5 | 18 | Yes | Yes |
| Example 3 | FIGs. | FIGs. | Resin 1 | Resin 2 | FIG. 11 | 18 | Yes | Yes |
| | 7, 8 | 9, 10 | | | | | | |
| Example 4 | FIG. 1 | FIG. 2 | Resin 1 | Resin 4 | FIG. 3 | 2 | Yes | Yes |
| Comparative | FIG. 1 | FIG. 2 | Resin 1 | Resin 3 | FIG. 3 | 4 | Yes | No |
| Example 1 | | | | | | | | |
| Comparative | FIG. 1 | FIG. 2 | Resin 1 | Inorganic | FIG. 3 | 0 | No | Yes |
| Example 2 | | | | solid | | | | |
| Comparative | FIG. 1 | FIG. 2 | Resin 1 | Resin 1 | FIG. 3 | 0 | No | Yes |
| Example 3 | | | | | | | | |

The results are shown in Table 1.

As can be seen in Comparative Example 3, in use of a firmly cross-linked material or a high-Tg resin (resin 1) as the insulating layer 10b for adhering negative electrode composite layers together, such a resin lacks elasticity and thus provides the insulating layer with less flexibility in spite of high strength. Comparative Example 2, which uses an inorganic solid layer, also exhibits less flexibility in the insulating layer 10b. Moreover, Comparative Example 1, which uses a thermoplastic resin (resin 3), includes a linear molecular structure and upon heating, melts to collapse a porous body, and thus loses most of ion permeability. By contrast, Examples 1 to 4 demonstrate that use of a base material and an adhesive porous insulating layer disposed on the base material and having a peel strength of 2 N/m or more enables production of an electrochemical element that has excellent flexibility of an insulating layer and ion permeability, reduced occurrence of stacking slippage of an electrode, and a good battery property.

Aspects of the present invention are as follows.
<1> A porous insulating layer-applied material for adhering an electrochemical element member including:
   a base material; and
   an adhesive porous insulating layer on the base material;
   the adhesive porous insulating layer being a porous structure having a co-continuous structure including a resin as a backbone, the resin being a cross-linked resin,
   wherein the adhesive porous insulating layer gives a peel strength of 2 N/m or more in a peel measuring method with use of a peel strength measuring element derived by preparing the base material as one of two base materials each having a size of 30 mm×100 mm, disposing the adhesive porous insulating layer through one entire face of each of the two base materials to provide adhesive porous insulating layers, placing the adhesive porous insulating layers to face each other, and performing thermal adhesion under conditions at a temperature of 140 °C and an air cylinder thrust of 500 N for 1 minute.
<2> The porous insulating layer-applied material according to Aspect 1, wherein the resin is a polymerization product of a polymerizable compound polymerizable by energy irradiation.
<3> The porous insulating layer-applied material according to Aspect 2, wherein the polymerizable compound has a (meth)acryloyl group.
<4> A stack including:
   the porous insulating layer-applied material according to any of Aspects 1 to 3; and
   another base material adhered to the porous insulating layer-applied material via at least a part of the adhesive porous insulating layer.
<5> An electrode including the porous insulating layer-applied material according to any of Aspects 1 to 3,
   wherein the base material has an electrode base, and the adhesive porous insulating layer is an outermost surface layer of the electrode.
<6> An electrochemical element including:
   a first electrode; and
   a second electrode insulated from the first electrode;
   the first electrode and the second electrode forming together a stack, and at least either of the first electrode or the second electrode being the electrode according to Aspect 5.
<7> The electrochemical element according to Aspect 6, wherein at least a part of the adhesive porous insulating layer is adhered to a surface of another base material.
<8> The electrochemical element according to any of Aspects 6 and 7, wherein the first electrode is disposed outside the second electrode and adhered to the second electrode via the adhesive porous insulating layer.
<9> The electrochemical element according to any of Aspects 6 to 8, the electrochemical element being a lithium-ion secondary battery.
<10> A stack including:
   a first base material; and
   a second base material,
   the first base material having a first adhesive porous insulating layer,
   the first base material and the second base material being adhered via the first adhesive porous insulating layer,
   the first adhesive porous insulating layer being a porous structure having a co-continuous structure including a resin as a backbone, the resin being a cross-linked resin,
   wherein the first adhesive porous insulating layer gives a peel strength of 2 N/m or more in a peel measuring method with use of a peel strength measuring element derived by disposing the first adhesive porous insulating layer through each of one entire face of a 30 mm×100 mm of the first base material and one entire face of a 30 mm×100 mm of the second base material to provide first adhesive porous insulating layers, placing the first adhesive porous insulating layers to face each other, and performing thermal adhesion under conditions at a temperature of 140 °C and an air cylinder thrust of 500 N for 1 minute.
<11> The stack according to Aspect 10, wherein the second base material has a second adhesive porous insulating layer; and the first base material and the second base material form together the stack so as to cause the first adhesive porous insulating layer to face the second adhesive porous insulating layer.
<12> The stack according to any of Aspects 10 and 11, wherein the first base material is an electrode, and the second base material is a film separator.
<13> The stack according to any of Aspects 10 and 11, wherein the first base material is an electrode; and the second base material is an electrode.
<14> The stack according to any of Aspects 10 to 13, wherein a content of a binder in the first adhesive porous insulating layer is 0% by mass or more to 30% by mass or less.
<15> A method of producing a stack, including:
   forming a first adhesive porous insulating layer in a first base material;
   stacking the first base material having the first adhesive porous insulating layer formed thereon and a second base material, so as to cause the first adhesive porous insulating layer to face the second base material; and
   adhering the first base material and the second base material thus stacked via the first adhesive porous insulating layer,
   the first adhesive porous insulating layer being a porous structure having a co-continuous structure including a resin as a backbone, the resin being a cross-linked resin,
   wherein the first adhesive porous insulating layer gives a peel strength of 2 N/m or more in a peel measuring method with use of a peel strength measuring element derived by disposing the first adhesive porous insulating layer through each of one entire face of a 30 mm×100 mm of the first base material and one entire face of a 30 mm×100 mm of the second base material to provide first adhesive porous insulating layers, placing the first adhesive porous insulating layers to face each other, and performing thermal adhesion under conditions at a temperature of 140 °C and an air cylinder thrust of 500 N for 1 minute.
<16> An electrochemical element including:
   the stack according to any of Aspects 10 to 13,
   wherein the first base material has an electrode base, and the second base material has an electrode base.
<17> A method of producing an electrode, including:
   forming an adhesive porous insulating layer on a base material having an electrode base,
   the adhesive porous insulating layer being a porous structure having a co-continuous structure including a resin as a backbone, the resin being a cross-linked resin,
   wherein the adhesive porous insulating layer gives a peel strength of 2 N/m or more in a peel measuring method with use of a peel strength measuring element derived by preparing the base material as one of two base materials each having a size of 30 mm×100 mm, disposing the adhesive porous insulating layer through one entire face of each of the two base materials to provide adhesive porous insulating layers, placing the adhesive porous insulating layers to face each other, and performing thermal adhesion under conditions at a temperature of 140 °C and an air cylinder thrust of 500 N for 1 minute.
<18> A method of producing of an electrochemical element, including:
   producing an electrode by the method according to Aspect 17; and
   producing an electrochemical element with the electrode.

The porous insulating layer-applied material for adhering an electrochemical element member according to any of Aspects 1 to 3, the stack according to any of Aspects 4, 10 to 14, the electrode according to Aspect 5, the electrochemical element according to any of Aspects 6 to 9 and 16, the method of producing a stack according to Aspect 15, the method of producing an electrode according to Aspect 17, and the method of producing an electrochemical element according to Aspect 18 can solve the conventional problems and achieve the purpose of the present embodiment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

This patent application is based on and claims priority to Japanese Patent Application No. 2022-157940, filed on Sep. 30, 2022, in the Japan Patent Office, the entire disclosure of which is hereby incorporated by reference herein.

### REFERENCE SIGNS LIST

1a: inkjet device
1b: ink container
1c: ink supply tube
2a: light irradiation device
2b: polymerization inert gas flowing device
3a: heating device
4: first electrode
5: conveyor part
6: porous membrane precursor
7: liquid composition
8: first electrode base
9: first electrode composite layer
10a: porous insulating layer porous insulating layer
10b: adhesive porous insulating layer
11: second electrode base
12: second electrode composite layer
13: sheet separator
100: printing part (adhesive porous insulating layer liquid-application unit)
100′: additional printing part (porous insulating layer liquid-application unit)
200: polymerization part
300: removal part
500: production apparatus for adhesive porous insulating layer

1-18. (canceled)

19. A stack comprising:
a first base material; and
a second base material,
the first base material having a first adhesive porous insulating layer, the first base material and the second base material being adhered via the first adhesive porous insulating layer, and
the first adhesive porous insulating layer being a porous structure having a co-continuous structure including a resin as a backbone, the resin being a cross-linked resin.

20. The stack according to claim 19, wherein the first adhesive porous insulating layer gives a peel strength of 2 N/m or more in a peel measuring method with a peel strength measuring element derived by disposing the first adhesive porous insulating layer through each of one entire face of the first base material having a size of a 30 mm×100 mm and one entire face of the second base material having a size of a 30 mm×100 mm to provide first adhesive porous insulating layers, placing the first adhesive porous insulating layers to face each other, and performing thermal adhesion under conditions at a temperature of 140 °C and an air cylinder thrust of 500 N for 1 minute.

21. The stack according to claim 19, wherein the resin is a porous insulating layer for adhering for an electrochemical element member.

22. The stack according to claim 19, wherein the resin is a polymerizable compound polymerizable by energy irradiation.

23. The stack according to claim 22, wherein the polymerizable compound has a (meth)acryloyl group.

24. The stack according to claim 19, wherein the second base material has a second adhesive porous insulating layer, and the first base material and the second base material form together the stack so as to cause the first adhesive porous insulating layer to face the second adhesive porous insulating layer.

25. The stack according to claim 19, wherein the first base material is an electrode, and the second base material is a film separator.

26. The stack according to claim 19, wherein the first base material is an electrode, and the second base material is an electrode.

27. The stack according to claim 19, wherein a content of a binder in the first adhesive porous insulating layer is 0% by mass or more to 30% by mass or less.

28. An electrochemical element comprising the stack according to claim 19.

29. A method of producing a stack, the method comprising:
forming a first adhesive porous insulating layer on a first base material;
stacking the first base material having the first adhesive porous insulating layer formed thereon and a second base material, so as to cause the first adhesive porous insulating layer to face the second base material; and
adhering the first base material and the second base material thus stacked via the first adhesive porous insulating layer,
wherein the first adhesive porous insulating layer is a porous structure having a co-continuous structure including a resin as a backbone, the resin being a cross-linked resin.

30. The method according to claim 29, wherein the first adhesive porous insulating layer gives a peel strength of 2 N/m or more in a peel measuring method with a peel strength measuring element derived by disposing the first adhesive porous insulating layer through each of one entire face of the first base material having a size of 30 mm×100 mm and one entire face of the second base material having a size of 30 mm/100 mm to provide first adhesive porous insulating layers, placing the first adhesive porous insulating layers to face each other, and performing thermal adhesion under conditions at a temperature of 140 °C and an air cylinder thrust of 500 N for 1 minute.

31. The method according to claim 29, wherein the adhering is performed by heating.

32. The method according to claim 29, wherein the adhering includes thermal adhesion under conditions at a temperature of 50 °C or more to 300 °C or less and an air cylinder thrust of 50 N or more to 1,000 N or less for 0.5 seconds or more to 10 seconds or less.

33. A method of producing an electrode, the method comprising:
producing a stack by the method according to claim 29,
wherein the first base material has an electrode base.
